(19) United States
(12) Patent Application Publication
(10) Pub. No.: US 2010/0141073 A1
(43) Pub. Date: Jun. 10, 2010

(54) IZUOGU MACHINE (THE TIME-LIMITED SELF SUSTAINING EMAGNETODYNAMICS MACHINE)

(76) Inventor: Ezekiel O. Izuogu, Abuja (NG)

Correspondence Address: Steve Witters, PLLC, 930 Woodland Ridge Circle, LaGrange, KY, 40031, US

(21) Appl. No.: 12/631,820

(22) Filed: Dec. 5, 2009

(30) Foreign Application Priority Data
Jun. 5, 2007 (IB) PCT/IB2007/052113

(51) Int. Cl. H02K 23/04; H02K 53/00

(52) U.S. Cl. 310/154.01; 415/916

(57) ABSTRACT

The present application relates to THE IZUOGU MACHINE (the time-limited self sustaining emagnetodynamics machine). The abstract of the disclosure is submitted herewith as required by 37 C.F.R.§1.72(b). As stated in 37 C.F.R.§1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CROSS-REFERENCE TO RELATED APPLICATIONS

This application is a Continuation-In-Part application of International Patent Application No. PCT/IB2007/052113, filed on Jun. 5, 2007, Publication No. WO 2008/149182 A1. The United States was an elected state in International Patent Application No. PCT/1B2007/052113.

### STATEMENT REGARDING FEDERALLY SPONSORED RESEARCH OR DEVELOPMENT

N/A

### ATTORNEY DOCKET NUMBER: 095 09 001

### Field

Aspects of the present invention generally relate to methods and apparatuses for the conversion of one form of energy into another form of energy or work, more specifically aspects of the present disclosure are directed toward an emagnetodynamics machine and method of use.

### Background

The present application discloses a device or machine and method for converting one form of energy into another form of energy or work. As reflected in the patent literature, much is disclosed about electric batteries and electric motors. The theory of magnetism and the theory of force exerted on a current carrying conductor in a magnetic field has been exploited in building the electric motor. An electric motor is a machine that converts electrical energy to mechanical energy. However, these electric motors may not convert all or any of the magnetic energy to mechanical energy.

What is needed are alternative methods and apparatus for converting magnetic energy into mechanical energy.

### SUMMARY

Aspects of the invention generally involve the interaction of rotor composite magnets against stator array of like poles.

Another aspect of the present invention discloses a machine using no vanes, but instead soft iron slabs are pasted on the big diameter rotor to work as composite magnetic poles.

In yet another aspect of the present invention only one plane is used.

In a further aspect of the present invention no feedback generators are used, and battery or electricity source works the system.

These and other features, aspects and advantages of the present invention will become better understood with reference to the following drawings, description and claims.

### BRIEF DESCRIPTIONS OF THE DRAWINGS

Modifications of the present application are disclosed according to the present application. The present application is explained more closely hereafter in conjunction with the Figures by a sample embodiment. There are shown:

FIG. 1 is a perspective view of a composite magnetic pole. It is a crescent shaped north and south poles of two permanent magnets held together on a brass or copper, or any nonmagnetic plate bent into the crescent shape. It is mounted on a non magnetic pivoted spindle;

FIG. 1A is a perspective view of a composite magnetic pole having crescent shaped north and south poles of two permanent magnets held together and mounted on a non magnetic pivoted spindle;

FIG. 1B is a perspective view of the composite magnetic pole. It is a crescent shaped north and south poles of two (or one) permanent magnets held together on a brass or copper, or any non-magnetic plate bent into the crescent shape. It is mounted on a non magnetic pivoted spindle;

FIG. 2 shows an array of north poles of similar magnets. (it could also have been south poles.) however, similar poles should be used for the system to optimally function.

FIG. 2A shows an array of north poles of similar magnets;

FIG. 3 shows the disposition of the magnetic poles of the magnets used to form the array of magnetic poles referred to in FIG. 2;

FIG. 3A shows a possible disposition of magnetic poles of the magnets used to form an array of magnetic poles referred to in FIG. 2A;

FIG. 4 shows the composite magnetic pole placed in the vicinity of the array of like poles;

FIG. 4A shows a composite magnetic pole placed in the vicinity of an array of like poles;

FIG. 5 is a composite magnetic pole, but this time made of a slab of soft iron core. It is mounted on a non magnetic, pivoted spindle;

FIG. 5A shows a composite magnetic pole comprised of a slab of soft iron core and mounted on a non magnetic, pivoted spindle;

FIG. 5B shows an ordinary soft iron composite magnetic pole that moves from F1 to F6;

FIG. 5C shows a composite magnetic pole shows a composite magnetic pole configured to move from F1 to F6, about a pivoted spindle;

FIG. 6 shows the angular disposition of the rotor vanes in each plane of a 4 plane machine;

FIG. 7 shows a design model of the complete self sustaining emagnetodynamics motor, with four planes mounted;

FIG. 7A shows the design model of a 4-plane substantially self-sustaining machine;

FIG. 7B shows a 4-plane emagnetodynamics machine;

FIG. 8 shows the electrical connections for the machine shown in FIG. 7;

FIG. 8A shows electrical connections for a four plane machine;

FIG. 9 shows the rotor vane with its stem;

FIG. 10 shows the permanent magnet that forms part of the composite polarity of the rotor or one of the permanent magnets that forms the composite pole. For example, it may be a 60×15×5 mm powerful ECLIPSE MAGNET bought from NAAFCO SCIENTIFIC, London. It gives an angler deflection of 15 degrees on a magnetometer placed some 300 mm away;

FIG. 11 shows the release electromagnets, 40, 42;

FIG. 11A shows a release electromagnet;

FIG. 12 shows an un-magnetized bar of iron;

FIG. 13 shows stators and vane on one plane;

FIG. 13A shows the disposition of stators and vane;

FIG. 14 shows the same bar of FIG. 12 now inside a solenoid;

FIG. 15 shows the clutch yoke for the machine;

FIG. 16 shows the clutch fork for the clutch assembly;

FIG. 17 shows the rotor for the machine;

FIG. 18 shows the clutch assembly;

FIG. 19 shows five horses pulling in different directions;

FIG. 20 shows the five horses pulling in the same direction;

FIG. 21 shows the machine with electromagnet stators giving a mathematical and experimental showing that it may achieve an efficiency of over unity

FIG. 22 shows the stator holder of a single plane machine, holding all seven permanent magnets that form the array of like poles. It is molded in aluminum;

FIG. 22A shows a stator holder, holding permanent magnets that form an array of like poles;

FIG. 23 shows one sample of stator magnet that forms the array. It may be a powerful Neodymium alloy magnet measuring 20 mm×20 mm×12 mm;

FIG. 24 shows the rotor of the single plane emagnetodynamics machine. It is made of aluminum and weighs 1 kg approximately;

FIG. 24A shows a rotor configured to operate in a single plane emagnetodynamics machine;

FIG. 25 shows the release electromagnet which may comprise a circular mildsteel composite magnet and the energizing coil, carrying 91 turns of insulated copper wire of diameter 1 mm;

FIG. 26 shows a fully set up one plane emagnetodynamics machine;

FIG. 26A shows a single plane emagnetodynamics machine;

FIG. 27 shows the electrical connections to the machine; and

FIG. 27A shows electrical connections to a single plane machine.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific aspects only. In other cases it will be recognized that references to the “invention” will refer to subject matter recited in one or more, but not necessarily all, of the claims. Each of the inventions is described in greater detail below, including specific aspects, versions and examples, but the inventions are not limited to these aspects, versions or examples, which are included to enable a person having ordinary skill in the art to make and use the inventions when the information in this patent is combined with available information and technology.

Various terms as used herein. To the extent a term used in a claim is not defined herein, it should be given the broadest definition persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable and any ranges shall include iterative ranges falling within the expressly stated ranges or limitations.

The present invention is in the technical field of physics, more particularly, the present invention is in the technical field of energy. Traditional electric motors operate on the theory of magnetism and the theory of force exerted on a current carrying conductor in a magnetic field. These electric motors convert electrical energy to mechanical energy.

Aspects of the present disclosure may provide an emagnetodynamic motor that may work on a different theory, namely the laws of emagnetodynamics. Emagnetodynamics is a branch of physics that studies the conversion of static magnetic energy into work. Aspects of the present disclosure may be referred to as a magnet motor or emagnetodynamics machine. The emagnetodynamics machine disclosed herein may utilize the inventor's first and second laws of emagnetodynamics. The first law states that a force is exerted on a composite magnetic pole in the vicinity of an array of like poles. The second law states that this force is in the direction of the composite polarity similar to the array. Aspects of the present disclosure may provide an emagnetodynamics machine, a self-sustaining emagnetodynamics machine, and a substantially self-sustaining emagnetodynamics machine.

A distinguishing feature of an emagnetodynamic motor disclosed herein, as compared to an electric motor, may be that while the conventional electric motor converts electrical energy to magnetic energy and then converts magnetic energy to mechanical energy, the emagnetodynamics machine may convert a portion or most all of the magnetic energy directly to mechanical energy, without going through the intermediary of current-carrying conductors.

Aspects of an emagnetodynamic motor disclosed herein may be self-sustaining, substantially self-sustaining, or substantially self-sustaining for a period of time. Aspects of an emagnetodynamics machine may generate a feedback current which may provide release from the backlash stators and therefore the machine may be able to run, without any external source of energy, for a period of time. This period of time may exceed 1 hour, in one minute increments, one day or more, in one hour increments, or even longer.

Embodiments of the invention are discussed below with reference to the Figures. However, those skilled in the art will readily appreciate that the detailed description given herein with respect to these figures is for explanatory purposes as the invention extends beyond these limited embodiments.

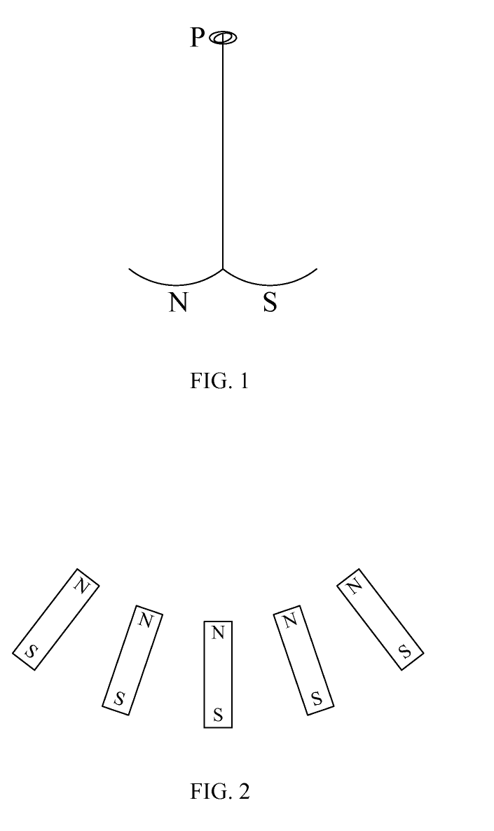

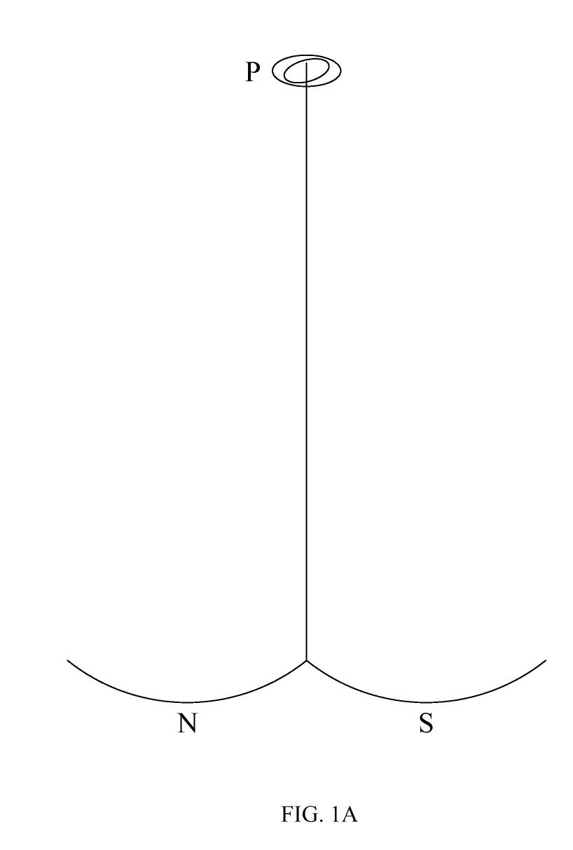

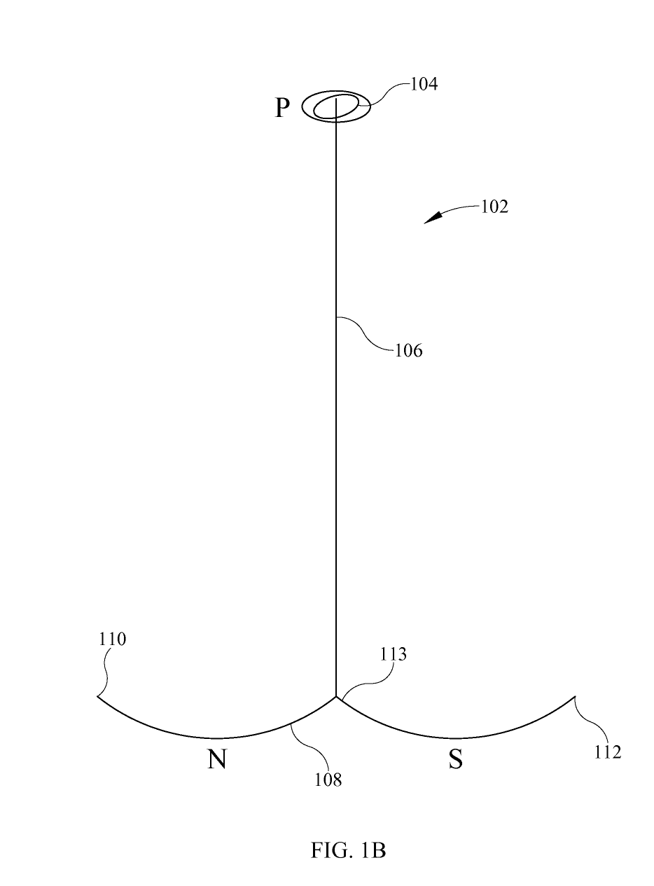

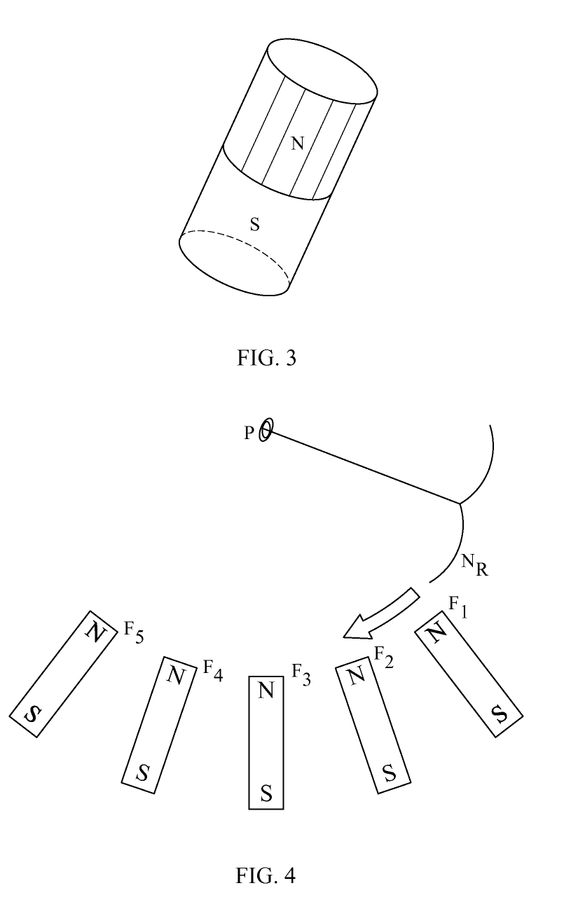

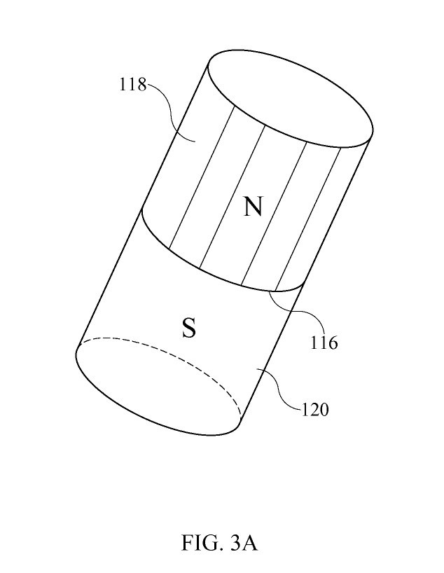

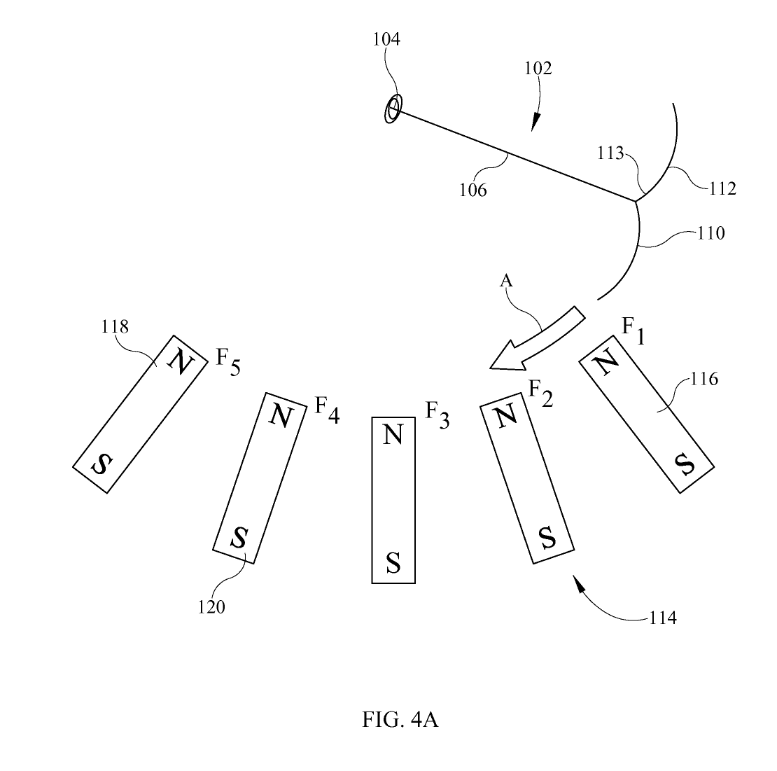

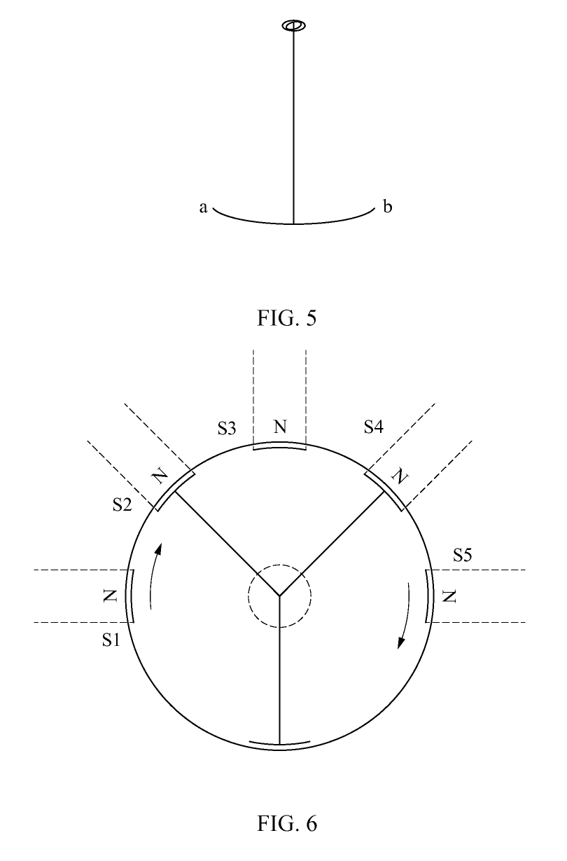

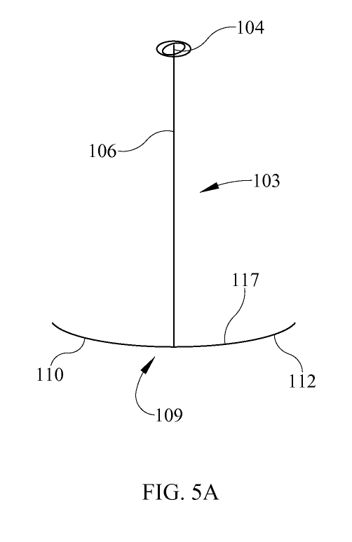

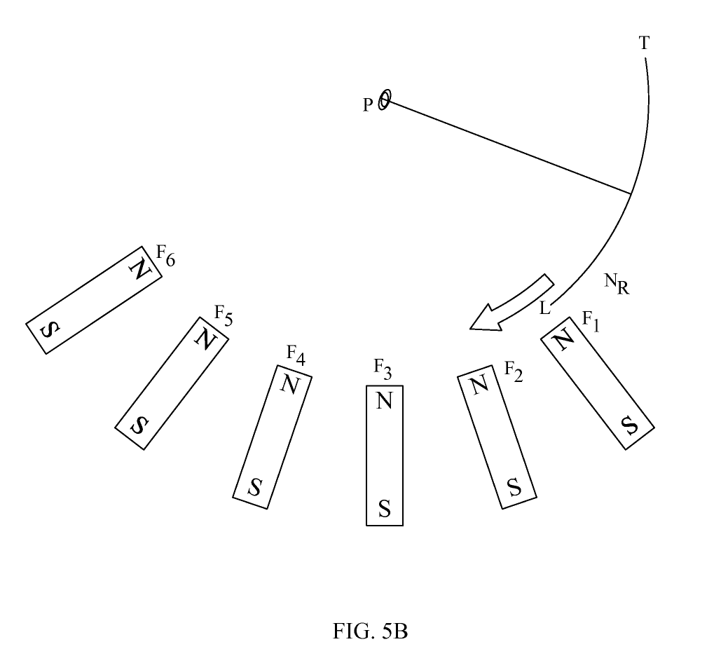

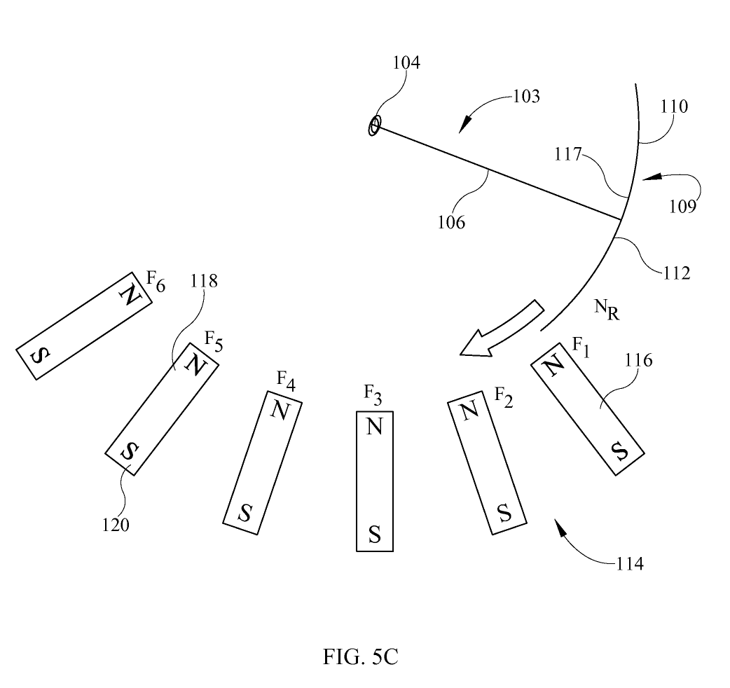

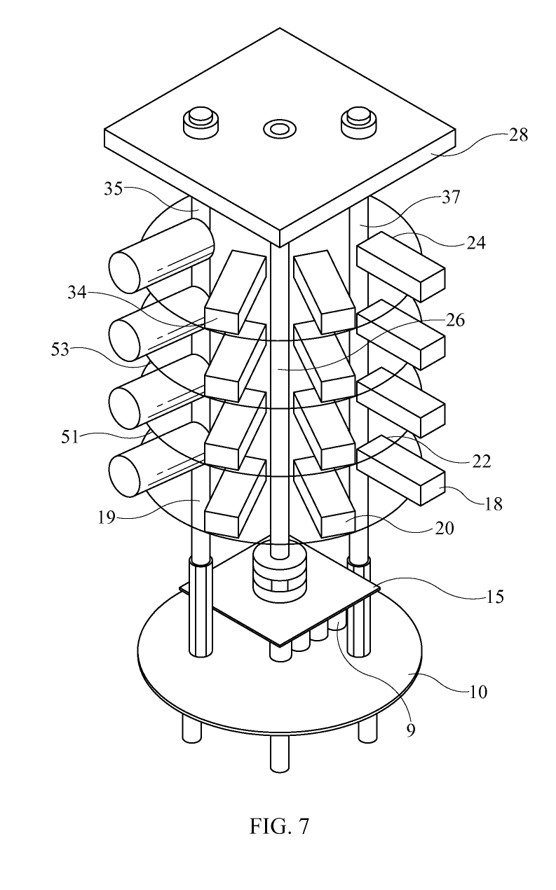

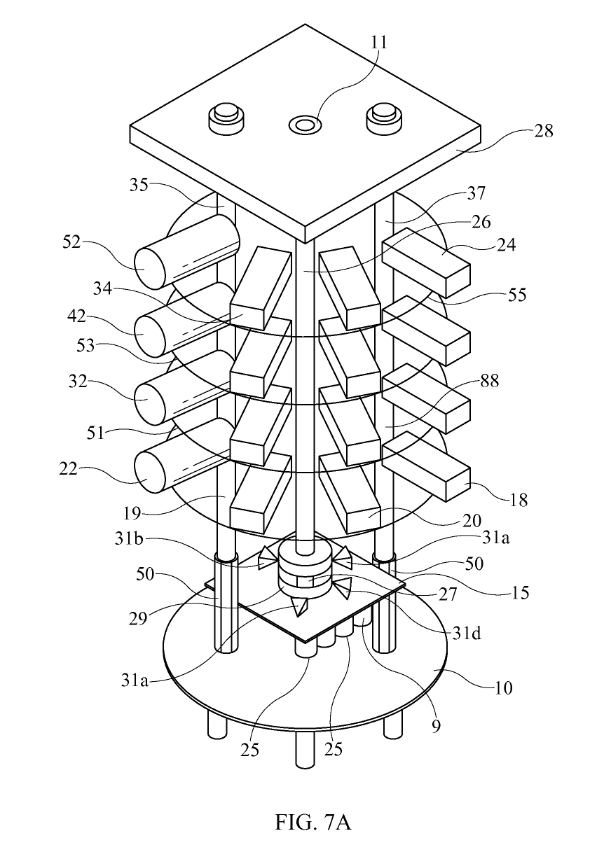

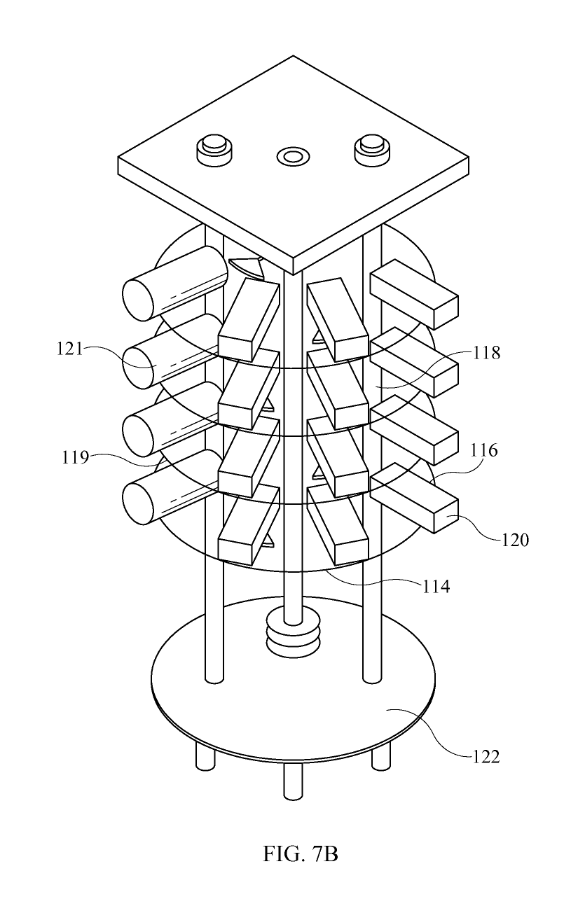

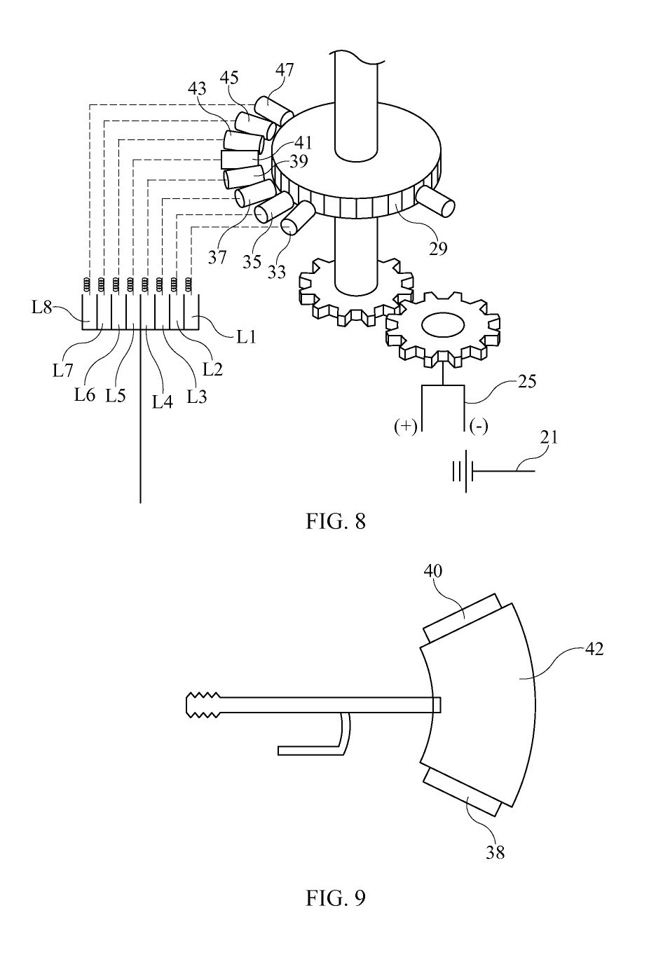

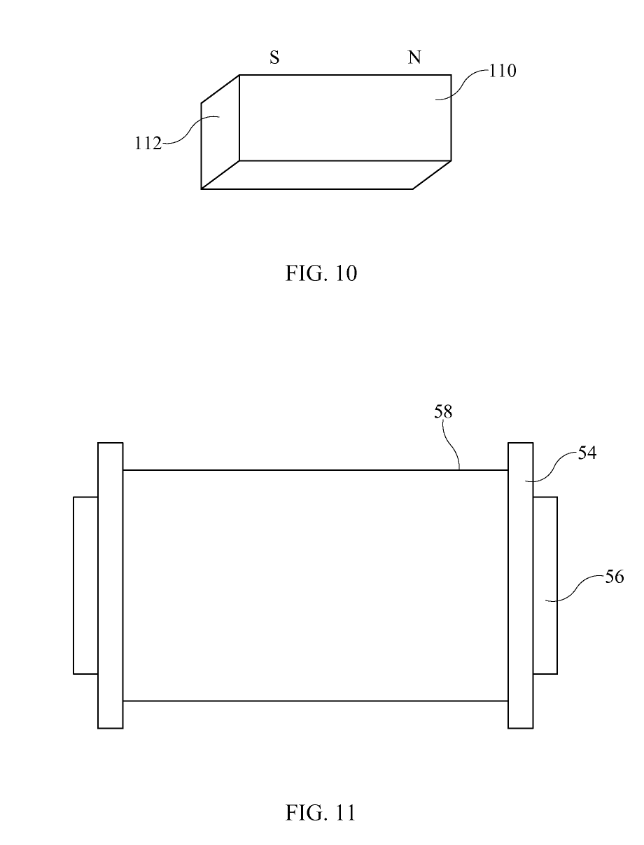

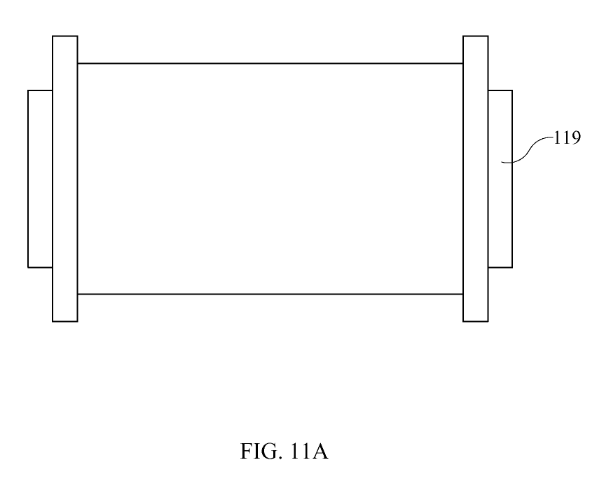

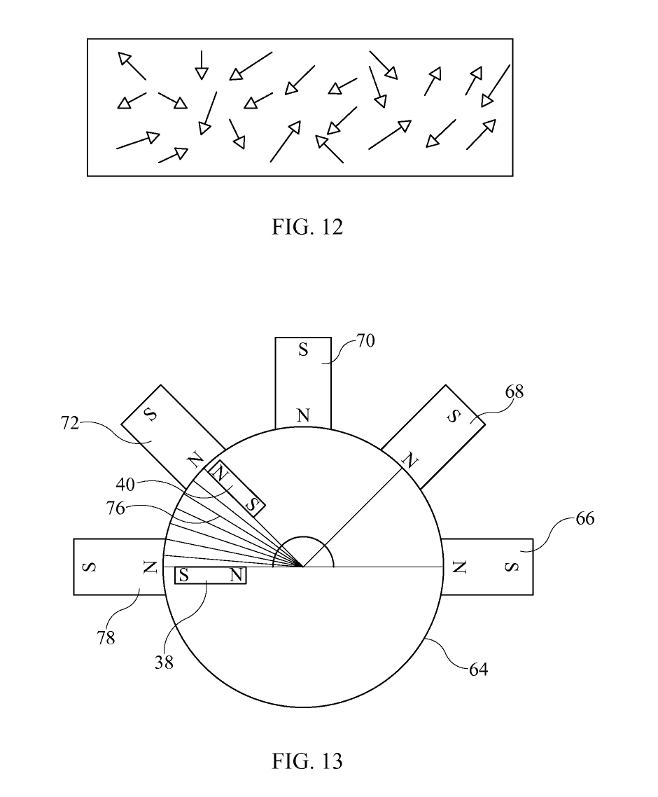

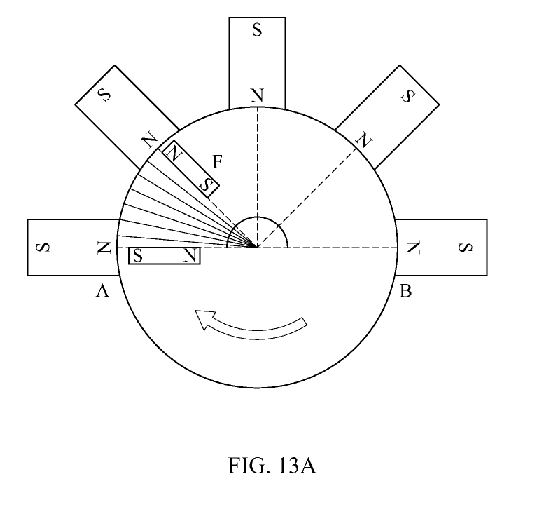

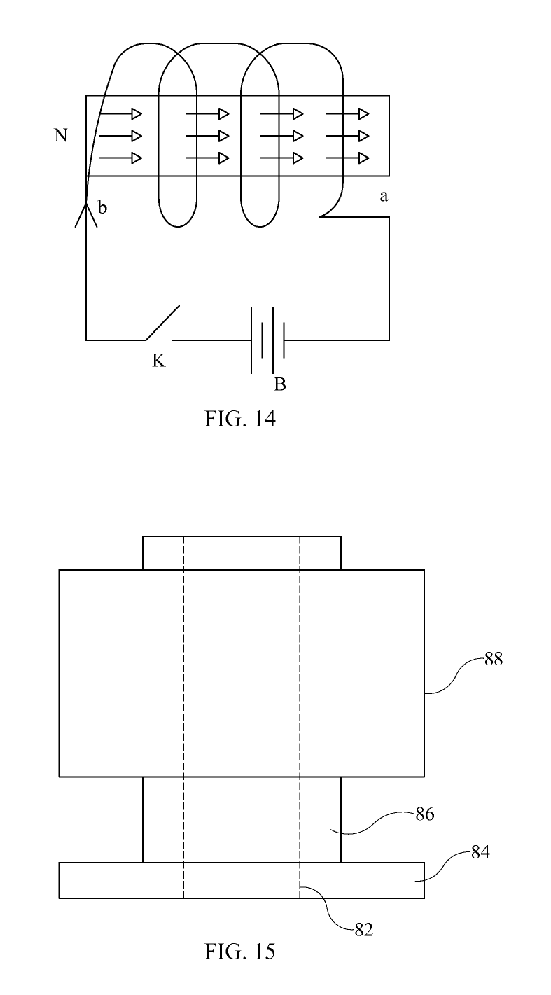

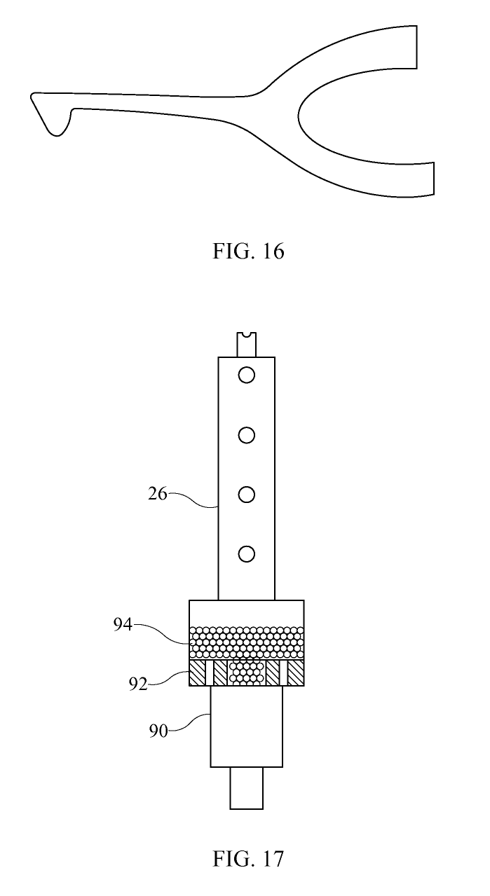

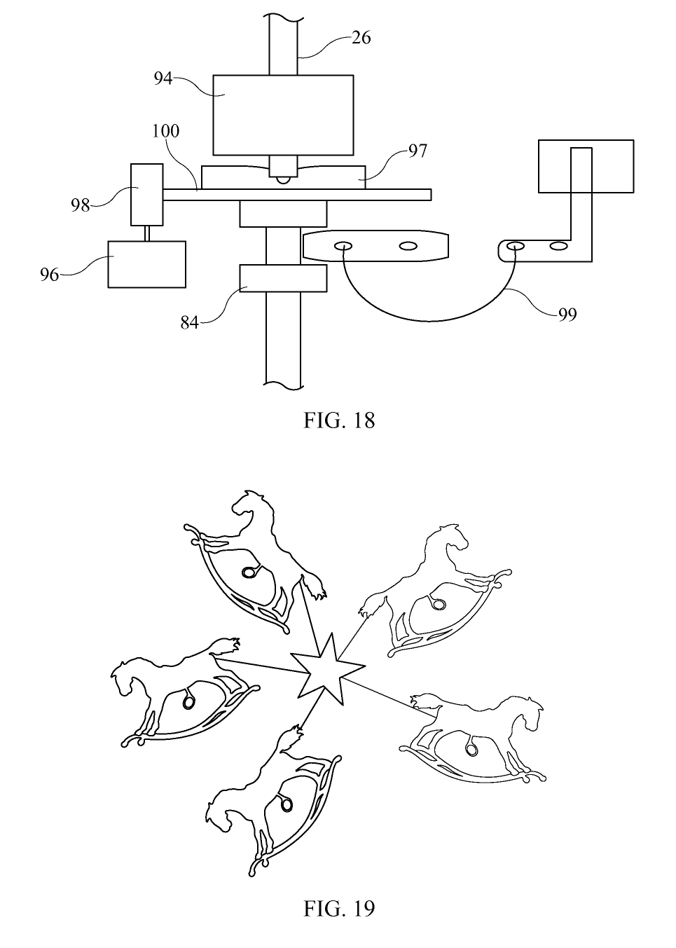

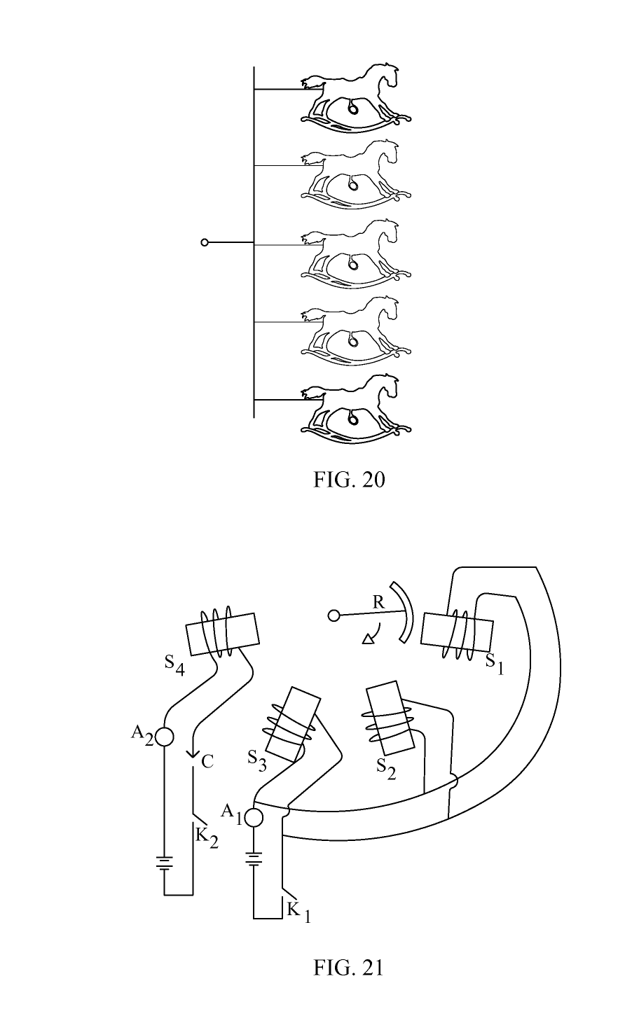

Referring now to the invention in more detail, in FIGS. 1 to 21 there is shown the machine and its component parts. In particular in FIG. 7 is shown the actual complete design of a four plane, self-sustaining, Emagnetodynamics machine with all components in place.

Two rods of brass 35,37 (diameter 25 mm, height 900 mm) threaded a length of 15 mm on each end) are mounted vertically on a horizontal circular brass plate 10, the brass rods carrying aluminum sleeves 50 to stabilize the system. The rotor 26 is installed into the lower ball bearing 9.

The rotor 26 has a section on its lower portion (Length 70 mm, diameter 60 mm) which also holds the distributor 27 and slip ring 29.

The Perspex 15 holding the carbon brushes 31, 33, 35,37,39,41,43,45,47 is now installed and secured by means of four copper bolts.

The circular Perspex plates 49,51,53,55, is each carrying three permanent magnets as 18,19,20 mounted on each plane, as well as the electromagnets 22,32. The five stators of a plane are placed round a circular hole of diameter 480 mm cut at the centre of Perspex. The stators cover an angle of 180 degrees. This means an angle of 45 degrees between one stator and its adjacent one. The circular distance, measured along the circumference of the circle between the centre of one stator and the adjacent stator, determines the circular length of the distance between the north and south poles of the composite polarity of the rotor. This circular Perspex plates 49,51,53,55 are now held firmly by sliding down the aluminum sleeves to tighten. The aluminum vanes 76 carrying the two permanent magnets, in each plane, that form the composite poles, are now tightened into place and the top end of the rotor is slid into the upper ball bearing 11 in the copper support 28. Nuts are now tightened at the threaded ends of the brass supports 35, 37 to make the system strong and rigid. A dc battery 21 is now connected to the release electromagnets via the ignition key 12, the motor 25 and the nine brushes. The d.c motor 25 is connected in parallels with the release electromagnets and is protected from the heavy current surge by a heavy duty resistor, 23.

Section 2:

The system is ready to run. As the ignition key 12 is turned, current from the battery 21 turns on the d.c motor 25, which turns the rotor in a clockwise direction (which must coincide with the direction in which the second law of Emagnetodynamics says the rotor will move). The motor 25 is able to turn the rotor 26 by means of wheel and pinion arrangement (The rotor 26 carries a cogged wheel 144 mm in diameter, while the motor carries a cogged wheel, 10 mm in diameter, much like a kickstarter in an internal combustion engine). The battery 21 simultaneously energizes the Distributor 27, and motor 25. The distributor 27 makes electrical contact with the brushes 33,35,37,39,41,43,45, thereby energizing the Release electromagnets much like a distributor in a conventional internal combustion engine would fire the four PLUGS. The first release electromagnet 22 in plane 1, is timed to develop a North Pole strength which must equal, or nearly so, the pole strength of the stator permanent Magnets. This must happen at the INSTANT that the magnetic axis of the leading composite pole of the rotor has just crossed the magnetic axis of the Electromagnet, 22. The rotor 26 moves on and at the point where the magnetic axis of the leading rotor composite pole is about to cross the magnetic axis of the last rotor permanent magnet 19, the distributor 27 makes contact with the second brush 35, thereby energizing the last stator electromagnet 32, and thereby freeing the trailing composite pole of the rotor, a South Pole which would have been otherwise attracted, and held back by the North pole of the last stator permanent magnet 19. This would have impaired the rotation of the rotor and stalled the machine. Being a four plane machine, torque exerted on the rotor by other stators in other planes, enables the rotor cover the idle distance and this brings it once more under the influence of the first stator electromagnet 22, whose iron core draws the leading north pole of the composite rotor pole under its influence and the process is repeated. The rotor is thus able to continue its rotation.

Notice that the four vanes all attached to the rotor but traversing different stators in different planes, are not disposed at an angle of 90 degrees each.

What we find, in FIG. 6 is that the first vane, V1 is leading the second vane V2 by an angle of 90 degrees. V2 leads V3 by an angle of 135 degrees, while V3 leads V4 by an angle of 67.5 degrees. The simple angler disposition of rotor vanes in a four plane machine would have been to divide 360 degrees by four so each vane will lead the following vane by 90 degrees. We have not adopted this simplistic approach in the design because it would have meant the distributor will energize more than one electromagnet at the same time. Since the electromagnets draw enormous current from the feedback generator, the latter may not cope with this great drain on its scarce energy, and the system may stall. To avoid this fatal situation, the vanes are disposed as shown in FIG. 6. For a six plane machine the disposition of vanes will again be different and so on. The whole idea in the design is to avoid a situation where more than one release electromagnet is energized at the same instant.

Referring now to FIGS. 7 and 7A, two rods of brass 35, 37 (diameter 25 mm, height 900 mm) threaded a length of 15 mm on each end) are mounted vertically on a horizontal circular brass plate 10, the brass rods carrying aluminum sleeves 50 to stabilize the system. The rotor 26 is installed into the lower ball bearing 9.

The rotor 26 has a section on its lower portion (Length 70 mm, diameter 60 mm) which also holds the distributor 27 and slip ring 29.

The Perspex 15 holding the carbon brushes 31(a), 31(b), 31(c), and 31(d) are installed and secured by means of four copper bolts.

The circular Perspex plates 49, 51, 53, and 55, are each carrying three permanent magnets as 18, 19, and 20 mounted on each plane, as well as the electromagnets 22, 32, 42, and 52. The four stators of a plane are placed around a circular hole of diameter 480 mm cut at the centre of Perspex. The stators cover an angle of 180 degrees. This means an angle of 45 degrees between one stator and its adjacent one. The circular distance, measured along the circumference of the circle between the centre of one stator and the adjacent stator, determines approximately, the circular length of the distance between the north and south poles of the composite polarity of the rotor. These circular Perspex plates 49, 51, 53, 55, are held firmly by sliding down the aluminum sleeves 50 to tighten. The aluminum vanes 76, carrying the two permanent magnets, in each plane, that form the composite poles, are tightened into place and the top end of the rotor is slid into the upper ball bearing 11 in the copper support 28. Nuts are now tightened at the threaded ends of the brass supports 35, 37 to make the system strong and rigid.

A 12 volt dc battery 21 is now connected to the release electromagnets via the ignition key 12, the feedback generators/motors 25 and the carbon brushes 31a, 31b, 31c, and 31d. The d.c motors 25 are of the size of tape recorder motors, or simply the radiator fan motor of a car, and are connected in parallels with the release electromagnets and is protected from the heavy current surge by a heavy duty resistor, 23.

The system is ready to run. As the ignition key 12 is turned, current from the battery 21 turns on the d.c. motor 25, which turns the rotor in a clockwise direction (which must coincide with the direction in which the second law of Emagnetodynamics says the rotor will move). The motor 25 is able to turn the rotor 26 by means of wheel and pinion arrangement (The rotor 26 carries a cogged wheel 144 mm in diameter, while the motor carries a cogged wheel, 10 mm in diameter, much like a kick starter in an internal combustion engine). The battery 21 simultaneously energizes the distributor 27, and motor 25. The distributor 27 makes electrical contact with the brushes 31a, 31b, 31c, and 31d, thereby energizing the release electromagnets, much like a distributor in a conventional internal combustion engine would fire the four plugs. The first release electromagnet 22 in plane 1, is timed to develop a North Pole strength which must equal, or nearly so, the pole strength of the stator permanent magnets. This must happen at the instant that the magnetic pole assembly axis of the leading composite pole of the rotor has just crossed the magnetic axis of the electromagnet, 22. The rotor 26 moves on and at the point where the magnetic axis of the leading rotor composite pole is about to cross the magnetic axis of the last rotor permanent magnet 19, the distributor 27 makes contact with the second brush 35, thereby energizing the last stator electromagnet 32, and thereby freeing the trailing composite pole of the rotor, a South Pole which would have been otherwise attracted, and held back by the North pole of the last stator permanent magnet 19. This would have impaired the rotation of the rotor and stalled the machine. Being a four plane machine, torque exerted on the rotor by other stators in other planes, enables the rotor cover the idle distance and this brings it once more under the influence of the first stator electromagnet 22, whose iron core draws the leading north pole of the composite rotor pole under its influence and the process is repeated. The rotor is thus able to continue its rotation.

Notice that the four vanes, V1, V2, V3, and V4, as shown in FIG. 6, are all attached to the rotor but traversing different stators in different planes, are not disposed at an angle of 90 degrees each. As shown in FIG. 7, is that the first vane, V1 is leading the second vane V2 by an angle of 90 degrees. V2 leads V3 by an angle of 135 degrees, while V3 leads V4 by an angle of 67.5 degrees. The simple angler disposition of rotor vanes in a four plane machine would have been to divide 360 degrees by four so each vane will lead the following vane by 90 degrees. In the embodiment shown, we have not adopted this simplistic approach in the design because it may have meant the distributor will energize more than one electromagnet at the same time. Since the electromagnets draw enormous current from the feedback generator, the latter may not cope with this great drain on its scarce energy, and the system may stall. To avoid this situation, the vanes are disposed as shown in FIG. 6.

As the machine gathers speed using the battery to provide electrical power fed to the release electromagnets, the feedback generators also generate electrical power which is then used to replace the battery output by means of a changeover switch and the system can run on its own power for limited periods of time.

This is possible because all that is required at the release points is a pulse of heavy current which is produced using pulse circuits of capacitors or other pulse current-producing circuits.

In a five, or six, or twenty plane aspect of the machine, the angular disposition must or should be determined separately for each case just as a designer of an internal combustion engine designing a four, five or six cylinder engines, must or should for each engine decide the angular disposition of the projections on the cam shaft which in turn determine the firing sequence of plugs in the compression chamber.

From the foregoing, we can see that though we call this machine a magnet motor, in reality, and from a design standpoint, it may have more in common with the internal combustion engine, than it has with a conventional electric motor.

Section 3:

Referring to the FIG. 7, for the rotor 26 to rotate, it may be necessary to ensure that the circular length of the vane approximately equals the circular distance between one stator magnetic axis and the next one.

This may be a critical condition for the system to work. It may be equally essential that the pole strength of all stator permanent magnets are equal or else the first and second laws of Emagnetodynamics may not have been complied with and the machine may not function.

The Emagnetodynamics machine is essentially a magnet motor. It may therefore be necessary to ensure that only non magnetic metals are used to build all the parts of the machine or else critical magnetic field strength required at certain points will be weakened or impaired. All bolts, nuts, etc. are advantageously made of copper or brass or aluminum to avoid magnetic interferences and distortions which may critically undermine the set up.

Much like the plug of an internal combustion engine must be ignited at a particular timing, the release electromagnets should be ‘ignited’/energized at the proper timing in order to secure releases of the rotor 26 at the backlash points and keep the motor running. To maximize this precision timing, the positions of the carbon brushes, may be made adjustable, much like the timing chain, of an internal combustion engine. The brushes are mounted on bases that themselves move on circular grooves made on the rectangular Perspex, 15. When the appropriate timing position has been determined, the brush base is screwed unto the Perspex base by means of a brass bolt and brass nut.

Section 4:

Refer to FIG. 7 of the invention, the rotor 26 is made of copper and is 870 mm high with holes made along its stem at various heights to take vane stems; these coincide with the heights of the four planes.

While the rotor 26 has big stem with a diameter of 60 mm, and length 70 mm, the rest of the body has a diameter of 30 mm. The slip rings 90,94 (width 10 mm and thickness 0.5 mm) are made of copper, which is both a good electrical conductor and non-rusting material. These are desirable properties to ensure there is always good electrical contact between the slip ring commutators and the brushes. the brush contact resistance should not be more than 0.2 Ohms. Of course the slip ring commutators are effectively insulated from any electrical contact with the rotor, using paper insulation as is done for a conventional electric motor commutator.

The permanent magnet stators, being the main source of torque exerted on the rotor 26 should be very powerful or else the resulting machine may be weak. In fact, the permanent magnet stators used by the inventor to build the working model of the non self sustaining emagnetodynamics machine each had magnetic pole strength that gave an angler deflection of 25 degrees on a magnetometer placed one meter away. The magnets were Alcomax magnets, but of course, since buying these magnets some twenty five years ago, more powerful magnets have been invented in the form of neodymium magnets.

An Emagnetodynamics machine having only one plane is like an internal combustion engine having only one cylinder, as against the traditional four cylinder/four stroke engine or a conventional electric motor running on only one coil. The practical Emagnetodynamics motor advantageously has many planes, at the very least four planes in order to produce a desired torque on the rotor 26 resulting in a powerful machine. The more the number of planes, the more powerful the resulting machine may be and it may be desirable to build machines with as many as 10 to 20 planes even though magnetic shielding may become of critical importance in order to shield the magnetic fields created by one plane from influencing the fluxes in an adjacent Plane.

Reference FIG. 21 of an embodiment of the invention. S1,S2,S3,S4 are electromagnet stators of a one plane machine. While S1,S2,S3 are all connected in parallels and energized together, S4 which is the release electromagnet is energized separately in a different circuit. It is found that for the system to rotate, some 120V should be fed to the three stators while 72 V should be fed to the release stator, S4. The current flowing in the first circuit as measured by ammeter A1 is 45A, while A2 read 6A.

If the power developed by this machine, rotating at 300 rpm is calculated it may be as follows:

1. 240 V source is the main power input to the motor.

The control or auxiliary input to the motor supplies relatively negligible power when K₂ is closed from the motor position at mmf axis of S₂ to mmf axis of S₄.

1. Power output of the motor is Rotor Torque times Rotor Speed in radians per second.

Pₒᵤₜ=T×w=ω=T×(300×2 π)/60=10πT watts.

1. Assuming lossless machine, Input Power=Output Power,

Power from S₁, S₂, S₃=45×240 W=10800 W.

Assuming that K₂ is on for 0 radians per revolution (from S₂ axis to S₄ axis), or 120 deg.

power from S₄=72×θ/2 π×6 W≈68.750 W.=144.4 W

(a) Percentage of power attributed to S₁ S₂ and S₃=10800×100/(10800+68.750).=98.7%

(b) Percentage of control power attributed to S=68.750×100/(10800+68.750).=1.3%

From this result it is clear that if a small feedback generator is linked to the rotor spindle, it may supply the 1.3% power required to work the release electromagnet and if we replace the electromagnets, s₁,s₂,s₃, with permanent magnets, we may have a machine whose efficiency is well over unity or that may be self-sustaining, self-sustaining for a period of time, substantially self-sustaining, or substantially self-sustaining for a period of time.

Section 5:

A different version of the self sustaining Emagnetodynamics machine may be built by adding a current booster in the circuit of the feedback generator. The output of the feedback generator is then fed into a pulse circuit, such as shown in FIG. 21. A pulse circuit is simply a circuit in which electrical energy is stored in a capacitor and discharged very fast. A large current flows for a very brief period. Since the release of rotor required at backlash points boils down to action at a point, lasting only a few milliseconds, the current pulse so produced may be enough to free rotor at backlash points.

DECEIT OF ENERGY: It can also be argued that the self-sustaining emagnetodynamics machine may exploit the principle of deceit of energy. This is explained this way:

In the conventional electric motor, full current must flow through the coils at any and every instant for the motor to function. This means heavy energy must be constantly supplied to the electric motor. For the emagnetodynamics machine, this may not be the case. We may not need heavy energy at every instant. We may need heavy energy only at the point where we need to secure the release of rotor vanes from the decelerating effects of backlask for a machine rotating at a speed of 600 rpm for example, we may need heavy current for a period of time.

A machine running at 600 rpm is doing 10 rps. The diameter of slip ring commutator is 60 mm and the width of distributor is 20 mm. So this distributor makes contact with a carbon brush for 0.01 seconds. This is one hundredth of a second, which is very short indeed. This is the pulse duration. Besides for the rest of the time that one revolution lasts, the permanent magnet stators, supply the torque needed for motion. The energy stored in the permanent magnets may be converted to mechanical energy.

The Television also uses the concept of deceit of the eye. Small spots from an object hitting the retina, stay on for a few seconds. If this happens fast enough, different spots appear continuous and the eye ‘sees’ the whole picture as one.

One may say that the emagnetodynamics machine sees the pulse of energy appearing at the backlash points as one continuous chain by virtue of energy gaps covered by the permanent magnet stators.

Section 6:

The advantages of the self sustaining Emagnetodynamics motor, over and above the conventional electric motor may be obvious. It may mean this motor can replace electric motors wherever electric motors are being used presently. This may include but are not limited to electric cars, trains, trolleys, electric fans, etc. Miniaturized emagnetodynamics machines, if built, may also replace electric motors in clocks, grinding machines, toys, etc. It may also be possible to install small emagnetodynamics machines to supply current to television sets and radios, so we may have these important gadgets that do not require electricity or battery to operate, or maybe less energy to operate.

Section 7

In broad embodiment, an aspect of the invention is a motor that works on the principle of interaction of permanent magnets, or even electromagnets, utilizing the laws of Emagnetodynamics as against the force exerted on a current-carrying conductor in a magnetic field.

Another version or aspect of the machine may use no vanes. The soft iron slabs are pasted on the rotor as angular dispersions. The rotor itself is made larger in diameter to accommodate this change in design. This version may also have only two split ring commutators, much like the conventional electric motor. The planes could be up to 30 or more and this may lead to a more sturdy and simple powerful machine that may do over 2000 rpm.

Figure B1 is a perspective view of a composite magnetic pole assembly 102 having two permanent magnets 108 held together on a brass or copper, or any nonmagnetic plate bent 113. Each permanent magnet 108 has a leading pole 110 (having a north or south polarity) and a trailing pole 112 (the other of a north or south polarity). Composite magnetic pole assembly 102 may be mounted on a non magnetic pivoted spindle 104.

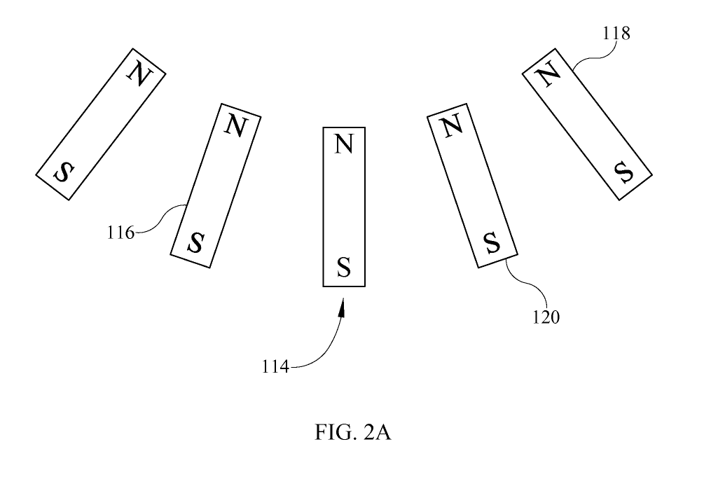

FIG. 2A shows an array of permanent magnets 114. Each stator magnet 116, in the array of permanent magnets 114, has a similar pole 118 arranged inwardly about an axis of a circle, in this embodiment shown these similar poles are north poles. However, it is to be understood that the south poles 120 could be arranged inwardly. However, similar poles must be used for the system to function.

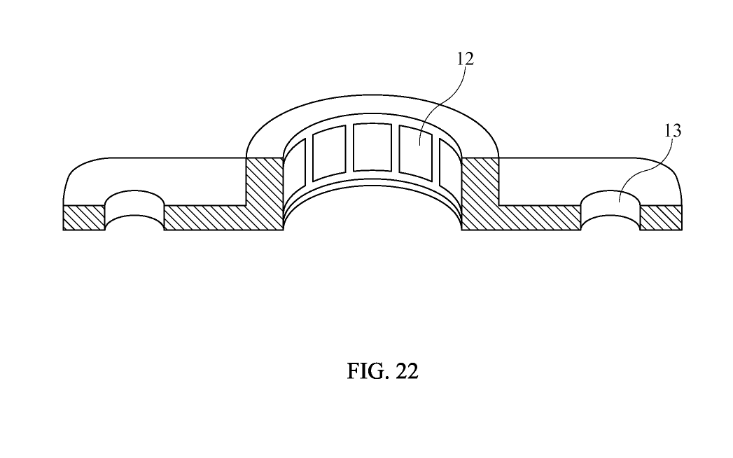

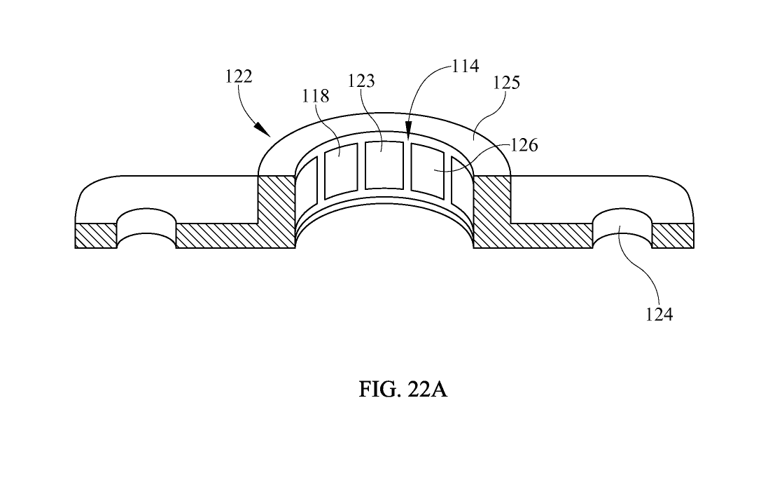

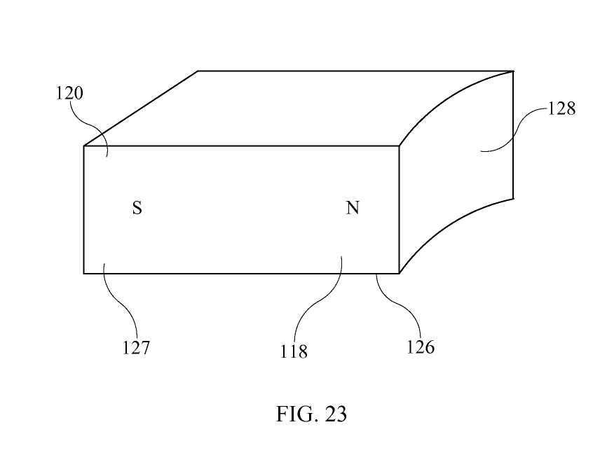

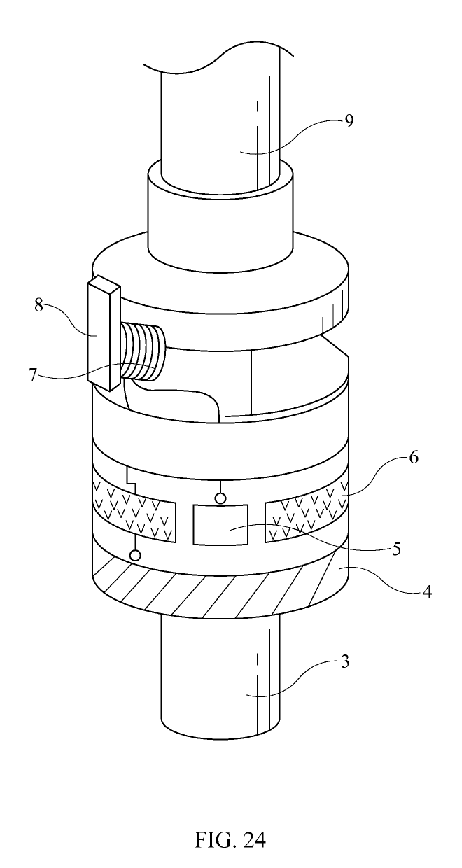

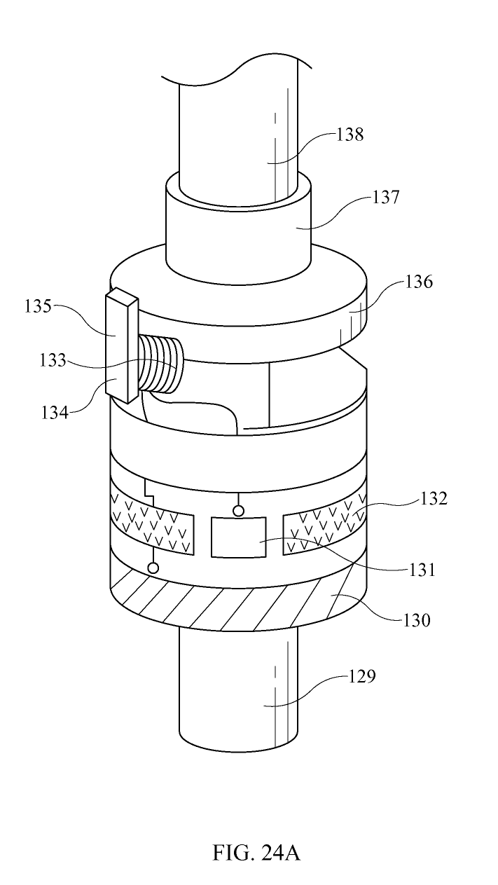

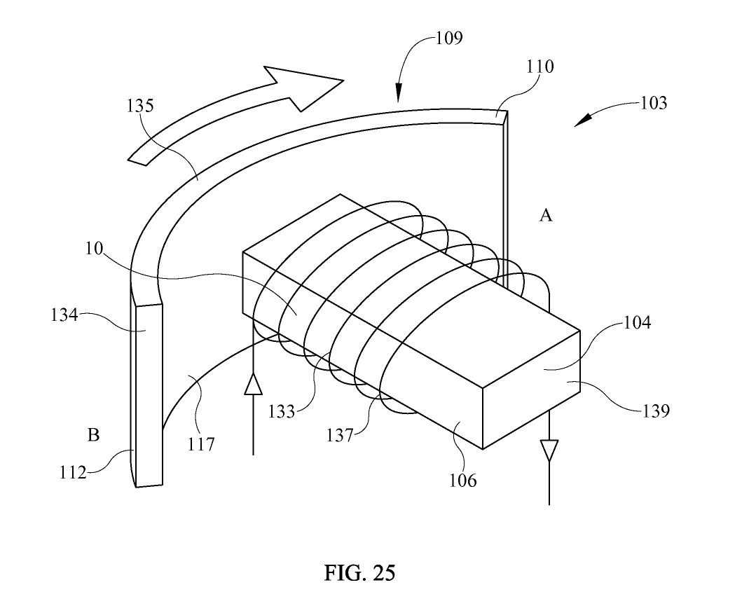

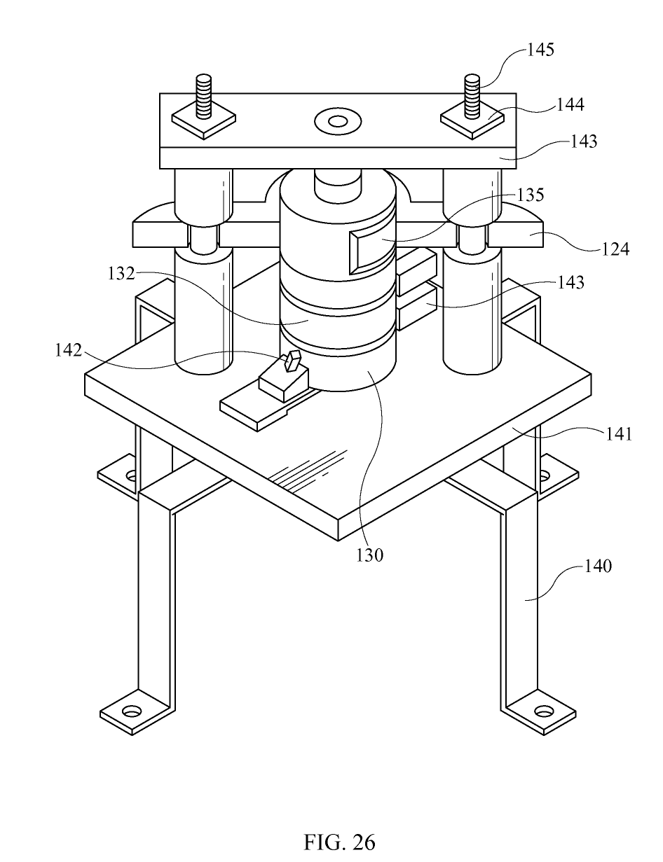

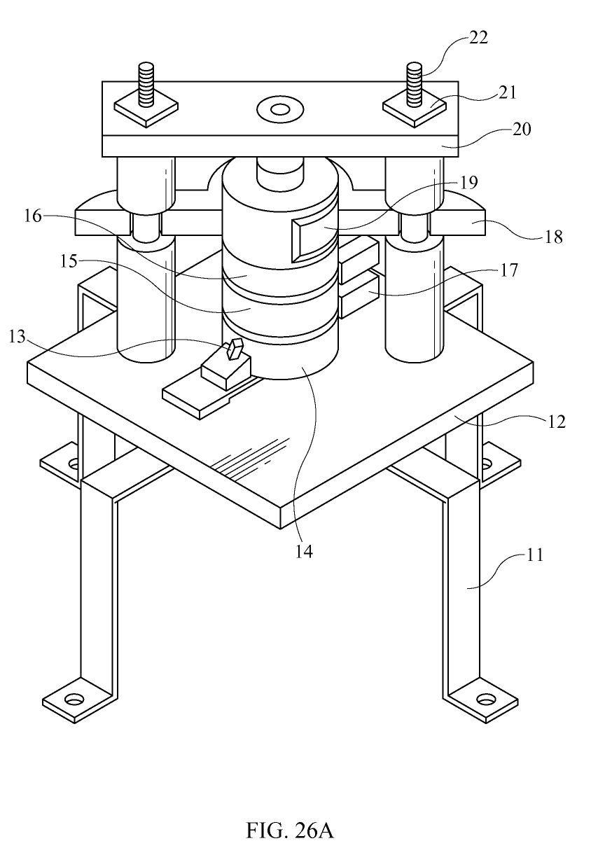

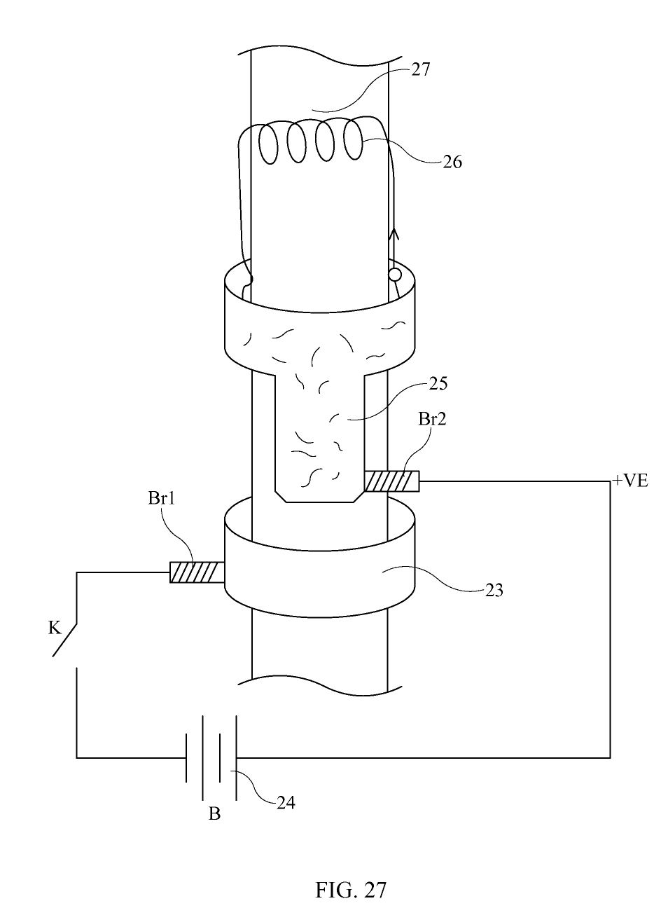

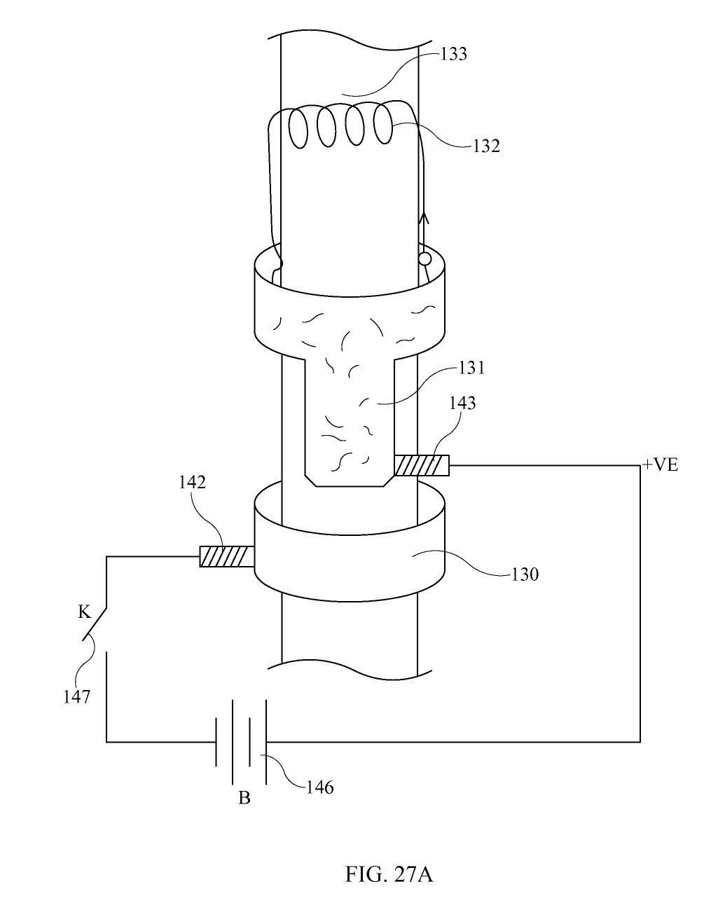

A single plane aspect of the present disclosure will now be disclosed. FIGS. 22 and 22A shows stator holder, holding all seven permanent magnets that form the array of like poles. It may be molded in aluminum. FIG. 23 shows one sample of stator magnet that forms the array. It may be a powerful Neodymium alloy magnet measuring 20 mm×20 mm×12 mm. FIGS. 24 and 24A shows s rotor of a single plane emagnetodynamics machine. It may be made of aluminum and may weigh 1 kg, approximately. FIG. 25 shows a release electromagnet which may comprise a circular mildsteel composite magnet and the energizing coil 133, may be carrying about 91 turns of insulated copper wire of diameter of about 1 mm. FIGS. 26 and 26A show a fully set up one plane emagnetodynamics machine. FIGS. 27 and 27A show electrical connections to the single plane machine.

Referring to FIGS. 22-27A, Item 12 is a rectangular Neodymium magnet stator, seven of them held firmly in the aluminum stator holder. The magnets are firmly tightened unto the stator holder and form a semicircle of diameter 60 mm. The two slots, 13, enable the stator holder to slide into the two vertical stands as in FIG. 26. FIG. 23 shows a stator magnet. Its north pole is circular and forms part of a circle of diameter 60 mm to mesh with the stator holder. FIG. 24 shows the machine rotor. Items 3, and 9 are the rotor ends that hold the ball bearings on the which the rotor is suspended. Item 4 is a slip ring commutator, advantageously made of copper. It may have a width of 10 mm and runs all round the rotor stem, which, itself may have a diameter of 57.6 mm, leaving the machine with an air gap of 1.2 mm. Item 5 is the distributor of the single plane embodiment of the machine. Item 6 is a strip of copper, about 10 mm wide and together with the distributor, form the split ring commutator of the machine. Item 7 is the release electromagnet coil of the machine, attached to the composite pole of the machine. Item 8 is the composite pole. It is a slab of mild steel plate of thickness 3 mm or similar thickness, circular length of 44 mm, or similar, and width of 20 mm, or similar. It is firmly attached to the rotor stem and forms part of the rotor assembly.

FIG. 25 shows the release electromagnet. The rotor vane (soft iron composite magnet poles), together with the electromagnet coil, double as release electromagnet. Item 133 is insulated copper wire, of diameter 1 mm, or similar dimensions, wound around a soft iron core attached to the composite pole. The electromagnet may have 91 turns (could be more or less) of this copper wire wound around it.

FIGS. 26 and 26A show a fully assembled single plane machine. Item 11 is one of four legs of the machine. It may be made of steel, or any rigid material to carry the whole machine weight. Item 12 is the machine bottom plate. It carries the ball bearing on which the rotor stands and rotates. The bottom plate measures about 220×220×25 mm, in at least one embodiment, and is made of brass or similar non magnetic metal so as to avoid distorting the magnetic field around the stator holders. Items 13,17 are carbon brushes that lead power into the electromagnet coils. Items 14 and 15 are the slip ring and split ring commutators. Item 18 is the stator holder and item 19 is the composite magnetic pole made of soft iron slab. Item 20 is the machine top plate. It may be comprised of a stainless steel plate or any similar non ferrous material. It may measures about, 282.5 mm×85×25 mm, in at least one embodiment. Item 21 are lock nuts and item 22 are threaded ends of the two vertical stands

FIGS. 27 and 27A show electrical connections for the single plane embodiment. Item B is a 12 V, 7AH, motorcycle battery, in at least one embodiment. Item K is a switch and items Br1,Br2 are carbon brushes. Item 25 is a distributor, with circular width of 15 mm, or similar, in at least one embodiment. Item 26 is a release electromagnet coil, C.

Referring now to the invention in more detail, in FIGS. 22 to 27A there is shown a single plane machine and its component parts. In particular in FIGS. 26 and 26A is shown a complete set up of the single plane emagnetodynamics machine, with components in place. Two rods of brass (diameter of about 20 mm, in at least one embodiment) threaded a length of about 15 mm on each end, in at least one embodiment, are mounted vertically on the bottom plate, 12, the brass rods carrying aluminum sleeves to stabilize the system. The rotor 15 is installed into the lower ball bearing. The rotor 15 also holds the distributor and slip and split rings of the machine. As already stated, the stator holder, 18, holds seven neodymium permanent magnets, in the embodiment shown.

The mechanical arrangement is such that both the stator holder and the composite pole are at the same vertical height, or essentially the same vertical height, so that the composite pole, 19, is exactly, or very close in the vicinity of the array of like north poles of the seven stator magnets. The electrical connections are such that no current is delivered to the electromagnet coils until the electromagnet attains an impending position with respect to the last stator permanent magnet.

Section 2:

With the electrical connections configured as in FIGS. 27 and 27A, the system is ready to run. In obedience to the first law of emagnetodynamics, the composite magnetic pole, being in the vicinity of an array of like poles, has force exerted on it. Since it is suspended along with the rotor carrying it, the composite pole, being a soft iron core, will tend to move in any direction, since at the very beginning, it possesses no magnetic pole of its own. At zero time, it is given a tilt, in order to decide if machine should rotate in a clockwise, or anticlockwise direction. For example, if the rotor is given a tap in a clockwise direction, the composite pole flies from the first stator magnet to the last stator permanent magnet and exceeds it, being only held back by the attraction of the last stator magnet. this is the impending position. In this position, over 90% of the composite pole circular length has crossed the magnetic axis of the last stator magnet. only its tail is gripped by the last stator magnet . . . and this stalls the motion.

In order to secure release for the composite pole, at this instant, the distributor, carrying current hits the carbon brush, BR2, thus energizing the coil C, in such a way that the trail tip, B, of the composite pole, in FIG. 25, develops a north pole for a fraction of a second. Since like poles repel, the trail tip B, is repelled by the north pole of the last stator magnet, thereby securing a release for the rotor and so motion is maintained in the clockwise direction. Each time the trail tip B of the composite pole hits the axis of the last stator magnet, the effect is repeated and so machine keeps spinning in the clockwise direction in line with the two laws of emagnetodynamics. Though the release may be due mainly to the repulsion between the two north poles, the coil is so wound that Flemings right hand rule is made to aid the process of release, though it may be done without.

Electrical power to the electromagnet is cut off quickly and as soon as release occurs so that the first law of emagnetodynamics can once more apply to give the rotor a powerful torque to spin.

An Emagnetodynamics machine having only one plane may be like an internal combustion engine having only one cylinder, as against the traditional four cylinders, four stroke engine or a conventional electric motor running on only one coil. The practical Emagnetodynamics motor may have many planes, at the very least, four planes in order to produce a desired torque on the rotor resulting in a powerful machine. The more the number of planes, the more powerful the resulting machine may be.

Section 7:

In a broad embodiment, the invention is a motor that works on the principle of interaction of permanent magnets, or even electromagnets, utilizing the laws of Emagnetodynamics as against the force exerted on a current-carrying conductor in a magnetic field.

Although specific embodiments of the invention have been disclosed, changes may be made to those embodiments without departing from the spirit and scope of the invention.

One feature or aspect of an embodiment may at the time of the filing of this patent application to possibly reside broadly in a machine that operates like an electric motor but whose torque development is dependent on the inventor's two laws of emagnetodynamics, the first law stating that force is exerted on a composite magnetic pole in the vicinity of an array of like poles while the second law states that the direction of this force is that of the composite polarity similar to the array.

Another feature or aspect of an embodiment may at the time of the filing of this patent application to possibly reside broadly in a machine that operates like an electric motor comprising permanent magnets in at least one stator wherein the permanent magnets are manufactured in such a way that one half of the magnet is north pole and the other half is south pole.

Yet another feature or aspect of an embodiment may at the time of the filing of this patent application to possibly reside broadly in a machine that operates like an electric motor comprising a release electromagnet forming the release rotor pole of the machine and is made to develop pole strength approximately equal to the pole strength of each of the stator permanent magnets, and is timed to get temporarily magnetized to develop the same polarity as the last one stator magnet, at an appropriate time when the rotor would have been otherwise held back by the attraction of the last stator permanent magnet.

Still another feature or aspect of an embodiment may at the time of the filing of this patent application to possibly reside broadly in a machine that operates like an electric motor comprising spindles and vanes holding composite magnetic poles made of non magnetic materials, such as brass or copper, so as not to distort the magnetic field created by the stator magnets.

A further feature or aspect of an embodiment may at the time of the filing of this patent application to possibly reside broadly in a machine that operates like an electric motor comprising a composite pole of that can be replaced by a soft iron disc which is bent in the same crescent shape for the reason that soft iron loses and gains magnetism very fast, and thus the soft iron rotor acts as a mirror image of stator permanent magnets.

Another feature or aspect of an embodiment may at the time of the filing of this patent application to possibly reside broadly in a machine that operates like an electric motor comprising a rotor so configured that the vane on which the composite poles are affixed, lies on a horizontal plane and rigidly fixed to the rotor which is either made of brass, copper or any other rigid but non magnetic matter.

Yet another feature or aspect of an embodiment may at the time of the filing of this patent application to possibly reside broadly in a machine that operates like an electric motor comprising composite magnetic poles attached to a rotor that can be configured in such a way that there are more than one composite pole, lying in different planes, but all attached to the same rotor, to increase the mechanical power deliverable by the machine much like the crank shaft of an internal combustion engine.

Still another feature or aspect of an embodiment may at the time of the filing of this patent application to possibly reside broadly in a machine that operates like an electric motor comprising dispositions of a stator and rotor of that can be reversed and the laws of Emagnetodynamics still apply to produce motion.

A further feature or aspect of an embodiment may at the time of the filing of this patent application to possibly reside broadly in a machine that operates like an electric motor comprising stators of which are permanent magnets that can be replaced with electromagnets without impairing the operation of the system.

Another feature or aspect of an embodiment may at the time of the filing of this patent application to possibly reside broadly in a machine that operates like an electric motor comprising a machine for utilizing the theory of emagnetodynamics (the branch of physics that studies the conversion of static magnetic energy into work) which translates, in simplest terms, to the controlled and orderly movement of magnets without the presence of current or current-carrying conductors.

Yet another feature or aspect of an embodiment may at the time of the filing of this patent application to possibly reside broadly in a machine that operates like an electric motor comprising a rotor composite magnetic pole that may experience both attractive and repulsive forces, from stator magnets, at the same time and in the same direction.

One feature or aspect of an embodiment may at the time of the filing of this patent application to possibly reside broadly in a substantially self sustaining machine that uses its own feedback current to operate, runs like an electric motor but uses little or none of the force exerted on a current carrying conductor in a magnetic field, but runs substantially by the interaction of magnetic poles between the stator and rotor and powered substantially by magnets and electromagnets, the main parts comprising a set of permanent magnets placed in a circular pattern, and forming the stators of the machine, and a composite magnetic pole attached to a spindle, forming the rotor, and a distributor pressing against brushes for releasing the rotor vanes (on each respective plane) from backlashes arising from repulsions/attractions of the rotor composite polarity.

Another feature or aspect of an embodiment may at the time of the filing of this patent application to possibly reside broadly in a substantially self sustaining machine comprising permanent magnets forming the stators, where the permanent magnets are manufactured in such a way that one half of the magnet is north pole and the other half is south pole.

Yet another feature or aspect of an embodiment may at the time of the filing of this patent application to possibly reside broadly in a substantially self sustaining machine comprising electromagnets which form a release stator pole of the machine and are made to develop pole strength approximately equal to the pole strength of each of the stator permanent magnets, and being timed to get temporarily magnetized at an appropriate time when the rotor would have been otherwise held back by a repulsion/attraction by the first stator permanent magnet.

Still another feature or aspect of an embodiment may at the time of the filing of this patent application to possibly reside broadly in a substantially self sustaining machine comprising spindles and vanes holding the composite magnetic poles, where the spindles and vanes are all made of non magnetic materials, such as brass or copper, so as not to distort the magnetic field created by the stator magnets.

A further feature or aspect of an embodiment may at the time of the filing of this patent application to possibly reside broadly in a substantially self sustaining machine configured to operate in accord with the inventor's first law of emagnetodynamics, where the first law states that a suspended composite magnetic pole will move in a certain direction if placed in the vicinity of an array of like poles of magnets.

Another feature or aspect of an embodiment may at the time of the filing of this patent application to possibly reside broadly in a substantially self sustaining machine configured to operate in accord with the inventor's second law of emagnetodynamics, where the second law states that the direction of rotation of the composite magnetic pole is that of the composite polarity similar to the array.

Yet another feature or aspect of an embodiment may at the time of the filing of this patent application to possibly reside broadly in a substantially self sustaining machine wherein a composite pole may be replaced by a soft iron disc which is bent in a crescent shape for the reason that soft iron loses and gains magnetism very fast, and thus the soft iron rotor may act as a mirror image of the stator permanent magnets.

Still another feature or aspect of an embodiment may at the time of the filing of this patent application to possibly reside broadly in a substantially self sustaining machine comprising brushes and commutators being made of copper or other non magnetic but non rusting metals.

A further feature or aspect of an embodiment may at the time of the filing of this patent application to possibly reside broadly in a substantially self sustaining machine comprising a rotor configured so that a vane on which the composite poles are affixed, lies on a horizontal plane and rigidly fixed to the rotor which is either made of brass, copper or any other rigid non-magnetic matter.

Another feature or aspect of an embodiment may at the time of the filing of this patent application to possibly reside broadly in a substantially self sustaining machine comprising vanes attached to a rotor which can be configured in such a way that there are more than one vane, lying in different planes, but all attached to the same rotor, to increase the mechanical power deliverable by the machine much like the crank shaft of an internal combustion engine.

Yet another feature or aspect of an embodiment may at the time of the filing of this patent application to possibly reside broadly in a substantially self sustaining machine comprising stator magnets which can be configured to lie in different planes of the machine to increase mechanical power deliverable by the machine.

Another feature or aspect of an embodiment may at the time of the filing of this patent application to possibly reside broadly in a substantially self sustaining machine comprising electrical power being delivered to a first or last electromagnet, and also to a small D.C. motor attached to the rotor, at the start of the machine through a switch, similar to the ignition key of a motor car.

Yet another feature or aspect of an embodiment may at the time of the filing of this patent application to possibly reside broadly in a substantially self sustaining machine comprising a D.C. motor mechanically linked to a rotor, where the D.C. motor is used to turn the rotor, at the ‘start’ of the emagnetodynamics motor, in a ‘KICK-START’ process.

Still another feature or aspect of an embodiment may at the time of the filing of this patent application to possibly reside broadly in a substantially self sustaining machine comprising stator magnets lying in different planes of the machine, the stator magnets are screened magnetically from each other so that their magnetic fields do not distort each other in operation.

A further feature or aspect of an embodiment may at the time of the filing of this patent application to possibly reside broadly in a substantially self sustaining machine comprising a disposition of a stator and a rotor that can be reversed and the first and second laws of Emagnetodynamics still apply to produce motion.

Another feature or aspect of an embodiment may at the time of the filing of this patent application to possibly reside broadly in a substantially self sustaining machine comprising stators which are permanent magnets that can be replaced with electromagnets without impairing the operation of the system or machine.

Yet another feature or aspect of an embodiment may at the time of the filing of this patent application to possibly reside broadly in a substantially self sustaining machine comprising a distributor, a kick starter, a multi-planed emagnetodynamics motor, which is configured to operate in accord with the first and second laws of emagnetodynamics similar to the operation of a hybrid vehicle, operating between the electric motor and the internal combustion engine.

Still another feature or aspect of an embodiment may at the time of the filing of this patent application to possibly reside broadly in a substantially self sustaining machine comprising system for utilizing the theory of EMAGNETODYNAMICS which translates, in simplest terms, to the movement of magnets without the presence of current or current-carrying conductors.

One feature or aspect of an embodiment may at the time of the filing of this patent application to possibly reside broadly in an emagnetodynamic machine comprising:

a stator comprising a circular section disposing an array of permanent magnets about a central axis, each of said permanent magnets in said array of permanent magnets being substantially equidistantly distributed along said circular section, each of said permanent magnets in said array of permanent magnets comprising magnetic material magnetically isolated and separated from each other, each of said permanent magnets in said array of permanent magnets comprising a magnetic pole having a like magnetic polarity proximate an inner side of said circular section and directed toward said central axis of circular section;

a rotor comprising a composite magnetic pole attached to cylindrical vanes or outer surface about a longitudinal axis of rotation, a first end, and a second end, said first and said second ends of said rotor extending substantially along said longitudinal axis of rotation of said rotor, said first and said second ends being rotationally mounted wherein a central portion of said rotor is configured to rotate within said central axis of said circular section of said stator; and

a release electro magnet disposed on said circular stator, and being configured to magnetically cooperate with the composite pole on rotor,

said composite pole being disposed about said cylindrical vanes with a leading magnetic pole and a trailing magnetic pole wherein said leading magnetic pole leads said trailing magnetic pole during rotation of said rotor;

said release electromagnet stator pole being timed to develop a magnetic polarity similar to the array of poles, and also timed to switch off at the point that the trailing magnetic pole of the composite pole is to released;

said composite pole being configured to provide a rotational force on said vane upon said composite pole becoming proximate each of said permanent magnets in said array of permanent magnets in said stator, the direction of said rotational force being that of the polarity of said composite pole similar to that of said array of permanent magnets.

Another feature or aspect of an embodiment is believed at the time of the filing of this patent application to possibly reside broadly in an emagnetodynamic machine wherein the dispositions of the stators and rotor can be reversed (with release electromagnet mounted on rotor, for example) and the laws of emagnetodynamics will still apply to produce motion.

Yet another feature or aspect of an embodiment is believed at the time of the filing of this patent application to possibly reside broadly in an emagnetodynamic machine wherein the composite magnetic pole can be replaced with ordinary soft iron core, and the emagnetodynamics machine will still operate.

Still another feature or aspect of an embodiment is believed at the time of the filing of this patent application to possibly reside broadly in a machine for utilizing the theory of emagnetodynamics, which translates, in simplest terms to the movement of magnets without the presence of current or current-carrying conductors.

A further feature or aspect of an embodiment is believed at the time of the filing of this patent application to possibly reside broadly in machine that could be self sustaining for limited periods of time.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

All of the patents, patent applications or patent publications, which were cited in the International Search Report dated Jun. 6, 2008, and/or cited elsewhere are hereby incorporated by reference herein as follows: DE 10 2004 043007 A1, having inventor MUELLER WERNER KARL, published on Mar. 30, 2006; US 2004/183387 A1, having inventor MOE JAMES ALFRED, published on Sep. 23, 2004; WO 94/01924 A, having inventor WHITEHALL DARRELL REGINALD, published on Jan. 20, 1994; EP 1 569 322 A, having inventor MINATO KOHEI. MINATO NOBUE, published on Aug. 31, 2005; DE 10 2005 036739 A1, having inventor RUPPRECHT GERD, published on Feb. 8, 2007; WO 92/22958 A, having applicant VAKUGO PTY LTD, published on Dec. 23, 1992. The patents, patent applications, patent publications, and other publications listed herein are incorporated by reference in their entirety herein, except words relating to the opinions and judgments of the author and not directly relating to the technical details of the description of the embodiments therein are not incorporated by reference. The purpose of incorporating U.S. patents, Foreign patents, patent publications, and other publications is solely to provide additional information relating to technical features of one or more embodiments, which information may not be completely disclosed in the wording in the pages of this application. The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments, are not to be incorporated by reference herein.

Any statements about admissions of prior art in the original foreign patent application PCT/IB2007/052113 are not to be included in this patent application in the incorporation by reference, since the laws relating to prior art in non-U.S. Patent Offices and courts may be substantially different from the Patent Laws of the United States.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.

Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL NOMENCLATURE

9, 11 Ball bearings at bottom and top, respectively,
10 Circular Brass plate which forms the base of the machine (Diameter 500 mm, Thickness 10 mm)
12 Ignition Key that switches on the machine (A typical motor car, e.g. Vauxwagen car, ignition key is adequate)
14 Group of feedback generators, serving also as KICKSTARTER
15 A rectangular Perspex plate (180×180×5 mm) that holds the carbon brushes.
16 Slip ring commutators
18, 19, 20 Permanent magnet stators of plane 1.
22, 32 Release electromagnets for plane 1
24, 36 Release electromagnets for plane 4
30 Clutch pedal
26 Rotor shaft, brass, 30 mm diameter
28 Rectangular plate of copper shackle.
21 Motor battery, 12 volts d.c.
23 A resistance suitable to protect the feedback generator/kickstart motor.
25 Kickstarter motor/feedback generator, 12 volt d.c., rich in current.
27 Distributor, copper,
29 slip ring copper commutator,
31 carbon brush
33, 35, 37, 39, 41, 43, 45, 47 carbon brushes to energize release electromagnets.
38, 40 Rectangular permanent magnets that form the composite pole
42 The aluminum vane to hold the composite poles.
50 The vane stem made of brass, length, diameter 10 mm
52 Vane stabilizer length 25 mm, diameter 5 mm
52 Vane stabilizer length 25 mm, diameter 5 mm
54 Aluminum former for release electromagnet, length 150 mm, internal diameter
37.2 mm, external diameter 39 mm, wound with 0.5 mm diameter insulated copper wire having total resistance of 14 ohms.
56 Soft iron core for the electromagnet, length 160 mm, diameter 37 mm
38, 40 Rectangular permanent magnets that form the composite pole
66, 74 Release electromagnets.
68, 70, 72 Permanent magnet stators.
76 Aluminum vane
82 Internal hole of diameter
84 Circular arm diameter, and . . . wide.
86 Clutch shank outside diameter
88 Outer tube of outer diameter, . . . mm long.
26 Smaller rotor stem, diameter 30 mm,
90 slip ring commutator, carrying the distributor.
92 The idle copper separator
84, 94 As already described
26 Rotor shaft
96 Feedback generator,
98 Geared pulley on generator,
100 Geared flywheel attached to rotor shaft
97 Clutch fiber attached to fly wheel (made of leather material)
99 Clutch cable
102 Composite magnetic pole assembly
103 Alternative composite magnetic pole assembly
104 Pivot of rotor vane
106 Rotor spindle
108 Composite magnetic pole
109 Middle of soft iron composite magnetic pole
110 Leading pole of composite pole
112 Rear pole of composite pole
113 Nonmetallic support plate
114 South pole of one stator magnet, forming part of array of north poles
116 Neutral point/mid point of a stator magnet
117 Crescent shaped nonmetallic support plate
118 Vertical stand of machine
119 Active pole of release electromagnet
120 Inactive magnetic pole of stator magnet
121 Inactive magnetic pole of release electromagnet
F1-F5 Each permanent magnet in an array of permanent magnets
A Direction of rotation
122 Machine bottom plate
123 Active pole of stator magnet
124 Slot to hold stator holder in place
125 Stator holder cover
126 An alternative permanent magnet in an array of permanent magnets
129 Rotor spindle
130 Slip ring commutator
131 Machine distributor
132 Split ring commutator
133 Release electromagnet coil
134 Rear pole of release electromagnet
135 Leading pole of release electromagnet
136 Rotor yoke
137 Release magnet coil
139 Second end of rotor
140 Machine stand
142 Carbon brush
143 Carbon brush
144 Machine top plate
146 12 volt accumulator
147 Key K

1. An emagnetodynamic machine comprising:
a stator comprising a circular section disposing an array of permanent magnets about a central axis, each of said permanent magnets in said array of permanent magnets being substantially equidistantly distributed along said circular section, each of said permanent magnets in said array of permanent magnets comprising magnetic material magnetically isolated and separated from each other, each of said permanent magnets in said array of permanent magnets comprising a magnetic pole having a like magnetic polarity proximate an inner side of said circular section and directed toward said central axis of circular section;
a rotor comprising a composite magnetic pole attached to cylindrical vanes or outer surface about a longitudinal axis of rotation, a first end, and a second end, said first and said second ends of said rotor extending substantially along said longitudinal axis of rotation of said rotor, said first and said second ends being rotationally mounted wherein a central portion of said rotor is configured to rotate within said central axis of said circular section of said stator; and
a release electro magnet disposed on said circular stator, and being configured to magnetically cooperate with the composite pole on rotor,
said composite pole being disposed about said cylindrical vanes with a leading magnetic pole and a trailing magnetic pole wherein said leading magnetic pole leads said trailing magnetic pole during rotation of said rotor;
said release electromagnet stator pole being timed to develop a magnetic polarity similar to the array of poles, and also timed to switch off at the point that the trailing magnetic pole of the composite pole is to released;
said composite pole being configured to provide a rotational force on said vane upon said composite pole becoming proximate each of said permanent magnets in said array of permanent magnets in said stator, the direction of said rotational force being that of the polarity of said composite pole similar to that of said array of permanent magnets.

2. The emagnetodynamic machine of claim 1 comprising an energy feedback loop configured and disposed to transfer energy from said rotor to said feedback loop;
said feedback loop comprising a current generator attached to the rotor spindle and a current pulse generator and booster configured to serve and operate the release electromagnet.

3. The emagnetodynamic machine of claim 2 being configured to be substantially self-sustaining for at least 10 minutes.

4. The emagnetodynamic machine of claim 2 being configured to be substantially self-sustaining for at least 1 hour.

5. The emagnetodynamic machine of claim 3 being configured to be substantially self-sustaining for at least 1 day.

6. An emagnetodynamic machine comprising:
at least one plane;
each said plane comprising an array of permanent magnets;
each said array of permanent magnets comprising:
at least two permanent magnets disposed about a central axis in a stator;
each said permanent magnets in each said array of permanent magnets being substantially equidistantly distributed about the central axis;
each of said permanent magnets in each said array of permanent magnets comprising magnetic material magnetically substantially isolated and separated from each other permanent in each said array of permanent magnets; and
each of said permanent magnets in each said array of permanent magnets comprising a magnetic pole having a like magnetic polarity proximate the central axis;
at least one composite magnetic pole; and
a release electro magnet disposed and configured to magnetically cooperate with each said composite pole;
said composite pole comprising a leading magnetic pole and a trailing magnetic pole;
said release electromagnet being timed to develop a magnetic polarity similar to each said stator magnet, and also timed to switch off at the point that the trailing magnetic pole of each said at least one composite pole is to released;
each said composite pole being configured to provide a rotational force upon said composite pole becoming proximate each said at least two magnets stator in each said plane, the direction of said rotational force being that of the said composite polarity similar to that of said at least two magnet stator; and
a feedback loop comprising a current generator attached, a current pulse generator, and booster configured to serve and operate said release electro magnet.

7. A emagnetodynamic machine that uses its own feedback current to operate, runs like an electric motor but not using the force exerted on a current carrying conductor in a magnetic field, but runs by the interaction of magnetic poles between the stator and rotor and powered by magnets and electromagnets, the main parts comprising a set of permanent magnets placed in a circular pattern, and forming the stators of the machine, and a composite magnetic pole attached to a spindle, forming the rotor, and a distributor pressing against brushes for releasing the rotor vanes (on each respective plane) from backlashes arising from repulsions/attractions of the rotor composite polarity.

8. The emagnetodynamic machine of claim 7 wherein the permanent magnets forming the stators are manufactured in such a way that one half of the magnet is north pole and the other half is south pole.

9. The emagnetodynamic machine of claim 7 wherein the electromagnets form the release stator pole of the machine and are made to develop pole strength approximately equal to the pole strength of each of the stator permanent magnets, and being timed to get temporarily magnetized at an appropriate time when the rotor would have been otherwise held back by a repulsion/attraction by the first stator permanent magnet.

10. The emagnetodynamic machine of claim 7 wherein the spindles and vanes holding the composite magnetic poles are all made of non magnetic materials, such as brass or copper so as not to distort the magnetic field created by the stator magnets.

11. The emagnetodynamic machine of claim 7 wherein a first law of emagnetodynamics is utilized by the apparatus of claim 1, the first law of emagnetodynamics states that a suspended composite magnetic pole will move in a certain direction if placed in the vicinity of an array of like poles of magnets.

12. The emagnetodynamic machine of claim 7 wherein a second law of emagnetodynamics is utilized, said second law of emagnetodynamics states that the direction of rotation of the composite magnetic pole is that of the composite polarity similar to the array.

13. The emagnetodynamic machine of claim 7 wherein the said composite pole can infact be replaced by a soft iron disc which is bent in the same crescent shape for the reason that soft iron loses and gains magnetism very fast, and thus the soft iron rotor acts as a mirror image of the stator permanent magnets,

14. The emagnetodynamic machine of claim 7 wherein the brushes and commutators are made of copper or other non magnetic but non rusting metals.

15. The emagnetodynamic machine of claim 7 wherein the rotor is so configured that the vane on which the composite poles are affixed, lies on a horizontal plane and rigidly fixed to the rotor which is either made of brass, copper or any other rigid by non magnetic matter.

16. The emagnetodynamic machine of claim 7 wherein the vanes attached to the rotor and can be configured in such a way that there are more than one vane, lying in different planes, but all attached to the same rotor, to increase the mechanical power deliverable by the machine much like the crank shaft of an internal combustion engine.

17. The emagnetodynamic machine of claim 7 wherein the stator magnets can be configured to lie in different planes of the machine to increase mechanical power deliverable by the machine.

18. The emagnetodynamic machine of claim 7 wherein electrical power is delivered to the first or last electromagnet, and also to a small d.c. motor attached to the rotor, at the start of the machine through a switch, similar to the ignition key of a motor car.

19. The emagnetodynamic machine of claim 18 wherein the d.c. motor is mechanically linked to the rotor, is used to turn the rotor, at the ‘start’ of the emagnetodynamics motor, in a ‘kick-start’ process.

20. The emagnetodynamic machine of claim 19 wherein the stator magnets, and lying in different planes of the machine, are screened magnetically from each other so that their magnetic fields do not distort each other in operation.
